(19) United States
(12) Patent Application Publication
(10) Pub. No.: US 2024/0411279 A1
(43) Pub. Date: Dec. 12, 2024

(54) SYSTEMS AND METHODS FOR MANAGING COMPLEX SYSTEMS

(71) Applicants: Trustees of Tufts College, Medford, MA (US); Board of Regents of the Nevada System of Higher Education, Reno, NV (US)

(72) Inventors: Babak Moaveni, Winchester, MA (US); Eric Hines, Medford, MA (US); Hamed Ebrahimian, Reno, NV (US)

(21) Appl. No.: 18/692,902

(22) PCT Filed: Sep. 19, 2022
(86) PCT No.: PCT/US22/76646

§ 371 Date: Mar. 18, 2024

Related U.S. Application Data
(60) Provisional application No. 63/261,342, filed on Sep. 17, 2021.

(51) Int. Cl. G05B 13/04; G05B 13/02

(52) U.S. Cl. CPC G05B 13/042; G05B 13/027

(57) ABSTRACT

Systems and methods are provided for creating and using digital models of real-world systems with a learning or data assimilation method. The systems and methods may be used to create and/or use a quantifiable model of a real-world system formed of a variety of sub-systems. and create and/or manage or quantified error or bias of the model. The learning network may be used to jointly estimate model parameters, dynamic input loads, and the statistical characteristics of the prediction error that includes the effects of modeling error and measurement noise. The learning network may be an adaptive recursive Bayesian inference framework. The prediction error may be of the form of a non-stationary Gaussian process with unknown and time-variant mean vector and covariance matrix to be estimated.

### CROSS-REFERENCE TO RELATED APPLICATIONS

This application claims the benefit of U.S. Provisional Patent Application Ser. No. 63/261,342, filed Sep. 17, 2021, which is incorporated herein by reference for all purposes.

### STATEMENT REGARDING FEDERALLY SPONSORED RESEARCH N/A

### BACKGROUND

Many modern systems are formed from a variety of technologies, often including electrical systems, mechanical systems, computer systems, and any of variety of other systems or subsystems. For example, many industrial systems include mechanical infrastructure sub-systems, electrical sub-systems for operating the industrial system, and a computer sub-system for monitoring and/or controlling the operation of the electrical sub-systems or components.

In an effort to connect and coordinate operation of conglomerations of sub-systems, modeling has been employed. Furthermore, more recently, model updating has emerged as a tool for system identification, parameter estimation, damage identification, response reconstruction, and virtual sensing. Model updating, the process of inferring models from data, is prone to the adverse effects of modeling error, which is caused by simplification and idealization assumptions in the mathematical models. The prediction error is usually modeled as an independent Gaussian white noise process in a Bayesian model updating framework.

In the application of model updating, the unknown model parameters and/or input loads are estimated by minimizing the mismatch between the measured and model-predicted responses. This mismatch, referred to as the prediction error, encapsulates the measurement noise and the effects of model uncertainties, which include model parameter uncertainties and modeling error. Model parameter uncertainties can be reduced through the model updating process given favorable identifiability conditions. Modeling error is caused by mathematical idealizations, approximations, and simplifications in the numerical model. If not accounted for properly, modeling error can cause estimation bias resulting in incorrect and/or inaccurate model updating outcomes.

In the classic non-adaptive recursive Bayesian model updating formulation, also referred to as non-adaptive Bayesian filtering, the prediction error is often assumed to be an independent Gaussian white noise process (i.e., a stationary, zero-mean, uncorrelated Gaussian random process) for mathematical simplicity. This assumption results in a zero-mean Gaussian probability distribution function (PDF) for the prediction error with time-invariant covariance matrix. This limiting assumption can be violated in real-world conditions, perhaps most commonly due to the effects of modeling error. Incorrect characterization of the prediction error statistics will affect model updating performance and can result in biased estimation or divergence of updating parameters. It can also result in incorrect uncertainty quantification of model parameters, i.e., although the parameters may be estimated with reasonable accuracy, their uncertainty bounds may not be realistic.

To address this issue, Bayesian inference methods for joint model parameters, input loads, and noise identification have been proposed for structural and mechanical engineering applications. One Bayesian method for estimation of the diagonal entries of the prediction error covariance matrix has been proposed where the estimated covariance matrix is then fed into an extended Kalman filter (EKF) for joint state-parameter estimation. Other methods have used a dual adaptive filtering method to handle the effects of modeling error that consisted of a Kalman filter to estimate the diagonal entries of the prediction error covariance matrix based on a covariance-matching technique, and an unscented Kalman filter (UKF) to estimate the unknown model parameters.

The above-mentioned studies assume that the prediction error is uncorrelated in space and, therefore, noise identification is limited to the estimation of the diagonal entries of the prediction error covariance matrix. Other methods have relied upon an adaptive Kalman filter using two types of covariance-matching methods, i.e., forgetting factor method and moving window method to estimate the full covariance matrix of the prediction error jointly with the unknown model parameters. Other methods have combined the Kalman filter method with a covariance-matching method to estimate the full covariance matrix of the prediction error jointly with the state vector and unknown model parameters. Yet other methods have proposed a Bayesian method for joint estimation of the mean vector and covariance matrix of the prediction error. In this approach, the mean vector of the prediction error was assumed to have a Gaussian distribution, while an inverse-Wishart distribution was considered for the covariance matrix of the prediction error. First, the distributions were updated based on Bayesian inference and then mean estimates of the updated distributions were used in the UKF algorithm for joint parameter and state estimation. Importantly, this work only considers the mean vector and covariance matrix of prediction error as time-invariant.

Although these methods alleviated some of the limiting assumptions for the prediction error, the zero-mean Gaussian assumption still remains in addition to modeling errors. Thus, there remains a need for systems and methods that are not undermined by the adverse effects of modeling error, and prediction errors from Gaussian white noise processes.

### SUMMARY OF THE DISCLOSURE

The present disclosure overcomes the aforementioned drawbacks by providing systems and methods for creating and using digital models of real-world systems. In one example, the systems and methods provided herein may be used to create and/or use a quantifiable model of a real-world system formed of a variety of sub-systems, and manage or quantify error or bias of the model. In one non-limiting example, a learning network may be used to jointly estimate model parameters and the statistical characteristics of the prediction error that includes the effects of modeling error and measurement noise. The learning network may be an adaptive recursive Bayesian inference framework. The prediction error may be of the form of a non-stationary Gaussian process with unknown and time-variant mean vector and covariance matrix to be estimated. This provides the ability to account for the effects of time-varying model uncertainties in the model updating process. In a non-limiting example, a digital twin may be modeled for complex, real-world systems using a Bayesian physics-based digital twin based on an adaptive recursive Bayesian inference method.

In one configuration, a method is provided for managing a physical system with a computer system. The method includes generating, with the computer system, a physics-based model of at least one physical asset in the physical system. The method also includes collecting sensor data from sensors configured to record a parameter or a response of the at least one physical asset for training the physics-based model. The method also includes subjecting the physics-based model and the sensor data to a data assimilation process to generate or identify model parameters and/or input loads from the sensor data for the at least one physical asset and quantify a prediction error. The method also includes updating the physics-based model based upon the model parameters and the quantified prediction error to generate a physics-based digital twin and directing operation of the physical system using the physics-based digital twin and the input loads. In some configurations, the physics-based digital twin may be used for virtual sensing and response reconstruction, which is an approach to guide operation of the physical system using the physics-based digital twin.

In one configuration, a system is provided for modeling a physical asset. The system includes a computer system configured to: generate a physics-based model of the physical asset in a physical system and collect sensor data from sensors configured to record a parameter or a response of the physical asset for training the physics-based model. In some configurations, the sensors may be configured to record dynamic response quantities of the physical asset for training the physics-based model. The computer system may also be configured to subject the physics-based model and the sensor data to a data assimilation process to generate model parameters and/or input loads from the sensor data for the physical asset and quantify a prediction error. The computer system may also be configured to update the physics-based model based upon the model parameters and the quantified prediction error to generate a physics-based digital twin. In some configurations, the computer system may be further configured to direct operation of the physical system based upon the digital twin and the input loads. In some configurations, the input loads may be unmeasured input loads.

The foregoing and other aspects and advantages of the present disclosure will appear from the following description. In the description, reference is made to the accompanying drawings that form a part hereof, and in which there is shown by way of illustration a preferred embodiment. This embodiment does not necessarily represent the full scope of the invention, however, and reference is therefore made to the claims and herein for interpreting the scope of the invention. Like reference numerals will be used to refer to like parts from Figure to Figure in the following description.

### BRIEF DESCRIPTION OF THE DRAWINGS

FIG. 1 is a flowchart of non-limiting example steps for a Bayesian physics-based model or digital twin based on an adaptive recursive Bayesian inference method.

FIG. 2A is a diagram of a non-limiting example 3-story 1-bay steel moment frame.

FIG. 2B is a graph of non-limiting example ground acceleration time history of an earthquake.

FIG. 3 depicts graphs of non-limiting example estimated model parameters for methods of FIGS. 2A and 2B.

FIG. 4 is a graph of non-limiting example estimated prediction error mean of FIGS. 2A and 2B.

FIG. 5 is a graph of non-limiting example covariance of the prediction error of FIGS. 2A and 2B.

FIG. 6 is a graph of estimated absolute acceleration responses at each floor compared with the true/nominal counterparts of FIGS. 2A and 2B.

FIG. 7 is a graph of the moment-curvature response and the stress-strain response of FIGS. 2A and 2B.

FIG. 8 depicts graphs of non-limiting example estimated model parameters for methods of FIGS. 2A and 2B.

FIG. 9 is a graph of non-limiting example estimated prediction error mean of FIGS. 2A and 2B.

FIG. 10 is a graph of non-limiting example covariance of the prediction error of FIGS. 2A and 2B.

FIG. 11 is a block diagram of an example of a computer system that can perform the methods described in the present disclosure.

FIG. 12 is a block diagram of an example digital twin formed from a non-limiting example physics-based model, measurement data, and Bayesian inference approach.

### DETAILED DESCRIPTION

Systems and methods are provided for creating and using physics-based digital twins of a physical system with a Bayesian data assimilation process. In one example, the systems and methods provided herein may be used to create and/or use a quantifiable model of a real-world system formed of a variety of sub-systems, estimate the unknown/unmeasured input loads on the system, and create and/or manage or quantify error or bias of the model. In one non-limiting example, an adaptive recursive Bayesian inference framework may be used to jointly estimate model parameters, input loads and the statistical characteristics of the prediction error that includes the effects of modeling error and measurement noise. The prediction error may be of the form of a non-stationary Gaussian process with unknown and time-variant mean vector and covariance matrix to be estimated. This provides for accounting for the effects of time-varying model uncertainties in the model updating process. In a non-limiting example, a digital twin may be modeled for complex, real-world systems using a Bayesian physics-based digital twin based on an adaptive recursive Bayesian inference method.

In a non-limiting example, a digital twin may be modeled for an offshore wind turbines (OWTs) system using a Bayesian physics-based digital twin based on an adaptive recursive Bayesian inference method. A digital twin or updated model may be used for virtual sensing to reconstruct the unmeasured response components to manage a system, such as an OWT, in order to reduce operation and maintenance costs and improve maintenance efforts.

The prediction capabilities of data-driven models are only as good as their training dataset, because they do not inherently capture the mechanics-based response behavior of the OWT. The training dataset will necessarily depend on the OWT type, design, and site conditions (e.g., soil properties, foundation installation, wind/wave loadings, etc.) that can vary significantly from one OWT to another. The limited amount of available data from OWT farms, and the variety of design and operational configurations result in the lack of reliable training dataset for supervised learning techniques, which in turn can result in unsatisfactory predictive capabilities of these data-driven models. Specialized data-driven models have been developed and calibrated based on experimental and real-world data to predict the remaining life of components (e.g., drivetrain bearings, consumable components, and the like). Although useful, these methods lack a holistic system-level approach; they are localized and component-specific and lose sight of the overall system dynamics. Moreover, data-driven models still require the installation of various sensors at different locations, which results in the shortcomings highlighted earlier. These methods lack the physics-and mechanics-based principals that can be used to characterize the complex response behavior of OWTs. Creating a digital replicate based on the mechanics of the complex OWT system may significantly broaden and expand the predictive maintenance capabilities.

In a non-limiting example, a framework is provided for remote monitoring, diagnosis, and prognosis of OWT systems and components to guide wind farm management and maintenance. The technology framework may be a Bayesian physics-based digital twin based on an adaptive recursive Bayesian inference method. Physics- and mechanics-based models of the system may be used, and the model may be trained using sensory data.

The physics-based digital twin framework can be applied to an offshore wind turbine (OWT) system and its components, including foundation & soil, substructure & tower, drivetrain, blades, and to monitor and/or predict the lifetime of the involved components, and guide management and maintenance strategies. Components may include drivetrain bearings, consumable components, and the like. The methods in accordance with the present disclosure can be extended to fixed-based as well as floating OWTs. While the applications to different OWT components are different, they may all be based on a physics-based digital twin and may utilize the same mathematical backbone. Each application may use specific development, verification, and validation processes.

In a non-limiting example, the systems and methods in accordance with the present disclosure may be verified numerically using a 3 degree-of-freedom nonlinear mass-spring-damper system representing a 3-story 1-bay nonlinear steel moment frame excited by an earthquake. Comparison of the results with those obtained from a classical non-adaptive recursive Bayesian model updating method shows the efficacy of the systems and methods in accordance with the present disclosure in estimation of the prediction error statistics and model parameters.

The recursive Bayesian inference framework provides a mathematical basis to formulate model updating in the presence of uncertainties and noise. In this framework, the prediction error may be modeled as a random process characterized by a joint probability distribution function (PDF). The prediction error can be a correlated, non-stationary, non-white-noise, and non-Gaussian random process.

A recursive Bayesian inference formulation may be used to jointly estimate the unknown model parameters, unknown input loads, and the statistical characteristics of the prediction error. In non-limiting examples, the statistical characteristics include mean vector and covariance matrix of the prediction error, and the like. The prediction error may be modeled as a non-stationary Gaussian random process with time-variant mean vector and covariance matrix to be estimated iteratively and jointly with the unknown model parameters. In a non-limiting example, the estimation problem may be solved using a two-step marginal maximum a posteriori (MAP) estimation approach.

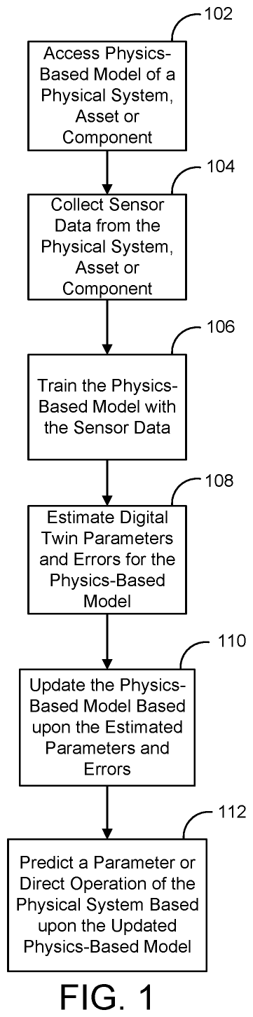

Referring to FIG. 1, a flowchart of non-limiting example steps for managing a complex physical system using a model is shown. In some configurations, a physics-based digital twin may be integrated with measured data based on an adaptive recursive Bayesian inference method. A physics-based model of a physical system, asset or a component of a system may be generated at step 102. The framework may include remote monitoring, diagnosis, and prognosis of a physical system or component. In a non-limiting example, the system is an OWT system and components to guide wind farm management and maintenance. Physical assets or components of an OWT include, but are not limited to blades, blade pitch system, gearboxes, protective coatings to prevent corrosion, hardware, bearings, tower, rotor, rotor shaft, brakes, grease, electrical components, control software, electrical generator, power cabling, wind sensors/anemometer or wind vane, yaw system, nacelle, and the like. The technology framework may be a Bayesian physics-based digital twinning based on an adaptive recursive Bayesian inference method. Physics-and mechanics-based models of the system may be used, and the model may be trained using sensory data.

Sensor data from the physical asset or system may be collected at step 104. Sensors may monitor wearable or consumable parts or components in order to track maintenance or other needs. Non-limiting examples include monitoring the wear of bearings, monitoring life expectancy of consumables (e.g. drivetrain components, and the like), determining the output of electrical generators, or assessing the response time of a yaw control system, the pitch angles a blade can achieve and the like. Sensors may include cameras, OPTICAL detectors, friction gauges, force gauges, accelerometers, strain gauges, clearance gauges, electrical current detectors, and the like. It is to be appreciated that any number of sensors may be used to monitor any number of systems, such as using a camera system along with a computer vision algorithm to measure the dynamic vibration or static deflection of a component, or to monitor the yaw control system. Any combination of sensors may also be used, such as to use a strain gauge to assess strain in a component in combination with an accelerometer to assess dynamic vibrations. The physics-based model may be trained with the sensor data at step 106.

Digital twin parameters for the physics-based model and errors of the model may be estimated at step 108, such as with a learning network or data assimilation process. In a non-limiting example, the learning network or data assimilation process uses a recursive Bayesian inference method. Digital twin parameters may include mechanical properties of the components, input dynamic forces, and the like, as described for sensors and monitoring above. The physics-based model may be updated based upon the estimated parameters and errors at step 110. A parameter of the physical system may be predicted, or operation of the physical system may be directed based upon the updated physics-based model representing a digital twin of the physical system at step 112. The predicted parameter or directed operation of the physical system may include virtual sensing, demand estimation, effects of wear, life prediction of the components, necessary maintenance, and the like.

In a non-limiting example, a physics-or mechanics-based model of the physical system may be utilized. Sensors may collect sparse data from the physical system. Through the framework, the information contained in data are integrated with the physics-based models using an adaptive Bayesian inference approach to reduce model uncertainties and provide improved prediction capabilities by estimating the modeling errors. The model, trained with data, represents a replicate of the physical system and is utilized for response and demand prediction, damage diagnosis, and remaining life prediction in various components.

In some configurations, the digital twin can account for the modeling errors and uncertainties, which in turn will be considered for estimation of remaining useful life of the OWT. The method uses the measured data to estimate jointly the input loads applied on the OWT and the parameters characterizing the physics-based model behavior. Through a dynamic sub-structuring approach, the complex OWT system is broken mathematically into different components, each may be characterized by a separate physics-based model. The physics-based model of each component will be trained with sensor data, to estimate the digital twin parameters and the error (both bias and variance) in a recursive manner as continuous monitoring data is collected. The methodology may underline the value of information and how having more sensors and data can reduce the estimation uncertainty of the remaining life prediction.

### Bayesian Inference Formulation for Joint Input, Model, and Noise Identification

A sequential window-based Bayesian filtering approach may be used for joint input, model and noise estimation using output-only vibration measurements such as acceleration, strain, velocity, or displacement. This approach may be applicable to linear and nonlinear structural or mechanical systems such as wind turbines, buildings, bridges, or aircrafts subjected to unknown (not measured) dynamic loadings such as wind, wave, earthquake, traffic, and the like. In this framework, the estimation time interval may be subdivided into N_{w} successive overlapping estimation. The estimation problem may be solved sequentially over sliding time windows.

The measured response vector of the structural system at estimation time window m, can be related to the response predicted through a numerical model,

$${y}_{{t}_{1}^{m} : {t}_{2}^{m}} = {h}_{{t}_{1}^{m} : {t}_{2}^{m}} ( {ψ}_{m} , {f}_{1 : {t}_{1}^{m} - 1} ) + {ω}_{{t}_{1}^{m} : {t}_{2}^{m}} ; {ω}_{{t}_{1}^{m} : {t}_{2}^{m}} ∼ N ( {μ}_{{t}_{1}^{m} : {t}_{2}^{m}} , {R}_{{t}_{1}^{m} : {t}_{2}^{m}} ) \qquad ( 1 )$$

in which

$${ψ}_{m} = {[ {θ}^{T} , {f}_{{t}_{1}^{m} : {t}_{2}^{m}}^{T} ]}^{T} ∈ {ℝ}^{( {n}_{θ} + {t}_{l} \times {n}_{t} ) \times 1}$$

is an extended unknown parameter vector at the mth estimation window including the time-invariant unknown model parameter vector θ∈ [symbol] ⁿ^{_{θ}}^{×1} and the unknown input time history

$${f}_{{t}_{1}^{m} : {t}_{2}^{m}} = {[ {f}_{{t}_{1}^{m}}^{T} , {f}_{{t}_{1}^{m} + 1}^{T} , … , {f}_{{t}_{2}^{m}}^{T} ]}^{T} ∈ {ℝ}^{( {t}_{l} \times {n}_{t} ) \times 1} .$$

n_{θ} is the number of unknown model parameters, nₜ is the number of unknown components in input time histories, and t₁=t₂^{m}−t₁^{m} is the number of time steps in estimation window.

$${y}_{{t}_{1}^{m} : {t}_{2}^{m}} = {[ {y}_{{t}_{1}^{m}}^{T} , {y}_{{t}_{1}^{m} + 1}^{T} , … , {y}_{{t}_{2}^{m}}^{T} ]}^{T} ∈ {ℝ}^{( {n}_{y} \times {t}_{1} ) \times 1}$$

is the vector of measured responses between time steps t₁^{m} and t₂^{m}, with n_{y} indicating the number of measurement channels.

$${h}_{{t}_{1}^{m} : {t}_{2}^{m}} ( {ψ}_{m} , {f}_{1 : {t}_{1}^{m} - 1} ) ∈ {ℝ}^{( {n}_{y} \times {t}_{1} ) \times 1}$$

is the response function of the linear or nonlinear model (e.g., finite element) between time steps t₁^{m} and t₂^{m}to an input force time history from time step 1 to t₂^{m}. For the sake of notation brevity,

$${h}_{{t}_{1}^{m} : {t}_{2}^{m}} ( {ψ}_{m} , {f}_{1 : {t}_{1}^{m} - 1} )$$

is replaced by

$${h}_{{t}_{1}^{m} : {t}_{2}^{m}} ( {ψ}_{m} )$$

henceforth. x˜N (x̅, Σ) denotes random vector x following a Gaussian (or Normal) distribution with mean vector x̅ and covariance matrix Σ, and the PDF of x is shown as

$$p ( x ) = N ( x \vert \overline{x} , Σ ) . {ω}_{{t}_{1}^{m} : {t}_{2}^{m}} = {[ {ω}_{{t}_{1}^{m}}^{T} , {ω}_{{t}_{1}^{m} + 1}^{T} , … , {ω}_{{t}_{2}^{m}}^{T} ]}^{T} ∈ {ℝ}^{( {n}_{y} \times {t}_{1} ) \times 1}$$

denotes prediction error vector accounting for the mismatch between the measured and model-predicted responses of the structure and may be modeled as a non-stationary Gaussian random process with unknown and time-variant mean vector

$${µ}_{{t}_{1}^{m} : {t}_{2}^{m}} ∈ {ℝ}^{( {n}_{y} \times {t}_{1} ) \times 1}$$

and covariance matrix

$${R}_{{t}_{1}^{m} : {t}_{2}^{m}} ∈ {ℝ}^{( {n}_{y} \times {t}_{1} ) \times ( {n}_{y} \times {t}_{1} )}$$

to be estimated recursively and jointly with the unknown model parameters and input time history ψₘ.

The prediction error may be independent across time. Furthermore, the mean vector

$${µ}_{{t}_{1}^{m} : {t}_{2}^{m}}$$

and covariance matrix

$${R}_{{t}_{1}^{m} : {t}_{2}^{m}}$$

of the prediction error may be time-invariant at each estimation window, i.e., for all k ∈ {t₁^{m}:t₂^{m}}, μₖ=\tilde{μ}ₘ and Rₖ=\tilde{R}ₘ, where \tilde{μ}ₘ ∈ [symbol] ⁿ^{_{y}}^{×1} and \tilde{R}ₘ ∈ [symbol] ⁿ^{_{y}}^{×n}^{_{y}} are time-invariant mean vector and covariance matrix of the prediction error at mth estimation window, respectively. Therefore, the estimation problem at each estimation window may be limited to estimation of ψₘ, \tilde{μ}ₘ and \tilde{R}ₘ.

To proceed with the Bayesian inference formulation, ψₘ and \tilde{μ}ₘ may be modeled as random vectors and \tilde{R}ₘ may be modeled as a random matrix. The estimation problem may be solved sequentially over all the estimation windows, and at each estimation window m, the framework may include “prediction” and “correction” steps. In the prediction step, the joint distribution of updating parameters, ψₘ, \tilde{μ}ₘ, and \tilde{R}ₘ are propagated from the previous window to the current estimation window through a dynamic model and they are used as prior information. In the correction step, prior estimates of the updating parameters, denoted as \hat{ψ}ₘ⁻, \tilde{\hat{μ}}ₘ⁻, and \tilde{\hat{R}}ₘ⁻are corrected to posterior estimates, denoted as \hat{ψ}ₘ⁺, \tilde{\hat{μ}}ₘ⁺, and \tilde{\hat{R}}ₘ⁺, using an iterative process through the Bayes' theorem by absorbing the information in the measurement between time steps t₁^{m} and

$${t}_{2}^{m} , {y}_{{t}_{1}^{m} : {t}_{2}^{m}} .$$

### Bayesian Inference Formulation

Using the Bayes' theorem, the joint posterior distribution of updating parameters, ψₘ, \tilde{μ}ₘ, and \tilde{R}ₘ, given the measured responses from time steps t₁^{m} and t₂^{m},

$${y}_{{t}_{1}^{m} : {t}_{2}^{m}} ,$$

can be derived as

$$p ( {ψ}_{m} , {\tilde{μ}}_{m} , {\tilde{R}}_{m} \vert {y}_{{t}_{1}^{m} : {t}_{2}^{m}} ) ∝ p ( {y}_{{t}_{1}^{m} : {t}_{2}^{m}} \vert {ψ}_{m} , {\tilde{μ}}_{m} , {\tilde{R}}_{m} ) p ( {ψ}_{m} , {\tilde{μ}}_{m} , {\tilde{R}}_{m} ) \qquad ( 2 )$$

where

$$p ( {y}_{{t}_{1}^{m} : {t}_{2}^{m}} \vert {ψ}_{m} , {\tilde{µ}}_{m} , {\tilde{R}}_{m} )$$

is the likelihood function and p(ψₘ, \tilde{μ}ₘ, \tilde{R}ₘ) is the joint prior distribution of ψₘ, \tilde{μ}ₘ, and \tilde{R}ₘ at mth estimation window. The normalizing (evidence) term may be ignored in Eq. (2); therefore, the sign “∝” denoting “proportional to” is used. The terms in the right-hand side of this equation may be expanded. Based on Eq. (1), the likelihood function follows a Gaussian distribution as

$$p ( {y}_{{t}_{1}^{m} : {t}_{2}^{m}} \vert {ψ}_{m} , {\tilde{μ}}_{m} , {\tilde{R}}_{m} ) = p ( {ω}_{{t}_{1}^{m} : {t}_{2}^{m}} ) = {\prod }_{k = {t}_{1}^{m}}^{{t}_{2}^{m}} N ( {ω}_{k} \vert {\tilde{μ}}_{m} , {\tilde{R}}_{m} ) \qquad ( 3 )$$

where

$$p ( {ω}_{{t}_{1}^{m} : {t}_{2}^{m}} ) = {\prod }_{k = {t}_{1}^{m}}^{{t}_{2}^{𝔪}} N ( {ω}_{k} \vert {\tilde{μ}}_{m} , {\tilde{R}}_{m} )$$

based on the assumption that the perdition error is independent across time.

The joint prior distribution, p(ψₘ, \tilde{μ}ₘ, \tilde{R}ₘ), can be written in a hierarchical form as

$$p ( {ψ}_{m} , {\tilde{μ}}_{m} , {\tilde{R}}_{m} ) = p ( {ψ}_{m} \vert {\tilde{μ}}_{m} , {\tilde{R}}_{m} ) p ( {\tilde{μ}}_{m} , {\tilde{R}}_{m} ) \qquad ( 4 )$$

in which p(\tilde{μ}ₘ, \tilde{R}ₘ) is referred to as hyper-prior with hyper-parameters of \tilde{μ}ₘ and \tilde{R}ₘ By substituting Eq. (4) into Eq. (2), it can be followed that

$$p ( {ψ}_{m} , {\tilde{μ}}_{m} , {\tilde{R}}_{m} \vert {y}_{{t}_{1}^{m} : {t}_{2}^{m}} ) ∝ p ( {y}_{{t}_{1}^{m} : {t}_{2}^{m}} \vert {ψ}_{m} , {\tilde{μ}}_{m} , {\tilde{R}}_{m} ) p ( {ψ}_{m} \vert {\tilde{μ}}_{m} , {\tilde{R}}_{m} ) p ( {\tilde{μ}}_{m} , {\tilde{R}}_{m} ) \qquad ( 5 )$$

The prior distribution of ψₘ may be approximated as Gaussian, i.e.,

$$p ( {ψ}_{m} \vert {\tilde{μ}}_{m} , {\tilde{R}}_{m} ) = N ( {ψ}_{m} \vert {\hat{ψ}}_{m}^{-} , {P}_{ψ , m}^{-} ) \qquad ( 6 )$$

where mean vector \hat{ψ}ₘ⁻ is the prior estimate for ψₘ, and P_{ψ,m}⁻ is the prior covariance matrix of ψₘ. Furthermore, the prior distribution of p(\tilde{μ}ₘ, \tilde{R}ₘ) may follow a Normal-Inverse-Wishart (NIW) distribution. In Bayesian statistics, NIW distribution may be used as the joint conjugate prior for the mean vector and covariance matrix of a Gaussian distribution. The conjugacy guarantees the same functional form for the posterior and prior distributions. NIW distribution is the product of a Normal (or Gaussian) distribution and an Inverse-Wishart (IW) distribution. The prior distribution of p(\tilde{μ}ₘ, \tilde{R}ₘ) in Eq. (5) can be expressed as

$$p ( {\tilde{μ}}_{m} , {\tilde{R}}_{m} ) = N I W ( {\tilde{μ}}_{m} , {\tilde{R}}_{m} \vert ( {\hat{\tilde{μ}}}_{m}^{-} , {λ}_{m}^{-} , {v}_{m}^{-} , {V}_{m}^{-} ) = N ( {\tilde{μ}}_{m} \vert {\hat{\tilde{μ}}}_{m}^{-} , \frac{{\tilde{R}}_{m}}{{λ}_{m}^{-}} ) I W ( {\tilde{R}}_{m} \vert {v}_{m}^{-} , {V}_{m}^{-} ) \qquad ( 7 )$$

where \tilde{\hat{μ}}ₘ⁻ ∈ [symbol] ⁿ^{_{y}}^{×1} is the prior mean vector of \tilde{μ}ₘ (also considered as prior estimate for \tilde{μ}ₘ), and λₘ⁻>0 is the confidence parameter. νₘ⁻>n_{y}−1 is the degree of freedom parameter and Vₘ⁻ ∈ [symbol] ⁿ^{_{y}}^{×}^{_{y}} is a symmetric positive definite scale matrix. Considering that p(\tilde{μ}ₘ, \tilde{R}ₘ)=p(\tilde{μ}ₘ|\tilde{R}ₘ)×p(\tilde{R}ₘ), the right-hand side of Eq. (7) can be separated as follows.

$$p ( {\tilde{μ}}_{m} \vert {\tilde{R}}_{m} ) = N ( {\tilde{μ}}_{m} \vert {\hat{\tilde{μ}}}_{m}^{-} , \frac{{\tilde{R}}_{m}}{{λ}_{m}^{-}} ) \qquad \text{(8-a)}$$

$$p ( {\tilde{R}}_{m} ) = I W ( {\tilde{R}}_{m} \vert {v}_{m}^{-} , {V}_{m}^{-} ) \qquad \text{(8-b)}$$

The Normal and IW distributions in Eq. (8-a) and (8-b) are defined below, ignoring normalizing terms.

$$N ( x \vert μ , \sum ) ∝ {\vert \sum \vert}^{- 1 / 2} exp ( - \frac{1}{2} {( x - μ )}^{T} {\sum }^{- 1} ( x - μ ) ) \qquad \text{(9-a)}$$

$$I W ( \sum \vert v , V ) ∝ {\vert \sum \vert}^{- ( v + {n}_{y} + 1 ) / 2} exp ( - \frac{1}{2} tr ( V {\sum }^{- 1} ) ) \qquad \text{(9-b)}$$

The terms |.| and tr(.) in these equations denote matrix determinant and matrix trace, respectively.

### Dynamic Models

The evolution of updating parameters ψₘ, \tilde{μ}ₘ, and \tilde{R}ₘ from estimation window m−1 to m may be characterized by a series of dynamic models. For propagating model parameter in the extended parameter vector

$${ψ}_{m} = {[ {θ}^{T} , {f}_{{t}_{1}^{m} : {t}_{2}^{m}}^{T} ]}^{T} ,$$

we can have \hat{θ}ₘ⁻=\hat{θ}ₘ₋₁⁺. For the input load time history, the estimated unknown input time history over the estimation window may be divided into two parts fₘ¹ and fₘ². The first part, from t₁^{m} to t₁^{m}+tₒ, which has overlap with the previous estimation window,

$${f}_{m}^{1} = {f}_{{t}_{1}^{m} : {t}_{1}^{m} + {t}_{0}} ,$$

can be transferred from the previous window and used as the initial estimate for the current estimation sequence. The second part, from

$${t}_{1}^{m} + {t}_{o} + 1 to {t}_{2}^{m} , {f}_{m}^{2} = {f}_{{t}_{1}^{m} + {t}_{∘} + 1 : {t}_{2}^{m}} ,$$

can be initialized with the average value of the first part. Therefore, \hat{ψ}ₘ⁻ can be written as

$${\hat{ψ}}_{m}^{-} = {[ {( {\hat{θ}}_{m}^{-} )}^{T} , {( {\hat{f}}_{{t}_{1}^{m} : {t}_{1}^{m} + {t}_{o}}^{-} )}^{T} , {( {\hat{f}}_{{t}_{1}^{m} + {t}_{o + 1 : {t}_{2}^{m}}}^{-} )}^{T} ]}^{T} = {[ {( {\hat{θ}}_{m - 1}^{+} )}^{T} , {( {\hat{f}}_{{t}_{1}^{m - 1} + {t}_{s} : {t}_{2}^{m - 1}}^{+} )}^{T} , avg ( {\hat{f}}_{{t}_{1}^{m - 1} + {t}_{s} : {t}_{2}^{m - 1}}^{+} ) \times {I}_{{t}_{s} \times 1} ]}^{T} \qquad ( 10 )$$

where tₛ is the sliding (or moving) rate defined as the difference (in number of time steps) between the starting point of two consecutive windows, i.e., tₛ=tₗ−tₒ. Iₜ_{ₛ}_{×1} is a vector of ones with the length of tₛ.

The uncertainties associated with model parameters and the first part of input load time history can be transferred from the previous window to the current window by deriving the conditional posterior covariance matrix from the previous window. The covariance matrix for the second part of the estimated input load time history can initialized as a diagonal matrix with identical diagonal entries. Therefore, we have

$${P}_{ψ , m}^{-} = [ \begin{matrix}{P}_{θ , {f}^{2} \vert {f}^{1} , m - 1}^{+} & 0 \\ 0 & {P}_{{f}^{2} , m}^{-}\end{matrix} ] + Q \qquad ( 11 )$$

where the conditional posterior covariance matrix P_{θ,f}_{²}_{f}_{¹}_{,m-1}⁺ may be defined as

$${P}_{θ , {f}^{2} \vert {f}^{1} , m - 1}^{+} = [ \begin{matrix}{P}_{θ , m - 1}^{+} & {P}_{θ {f}^{2} , m - 1}^{+} \\ {P}_{{f}^{2} θ , m - 1}^{+} & {P}_{{f}^{2} , m - 1}^{+}\end{matrix} ] - [ \begin{matrix}{P}_{θ {f}^{1} , m - 1}^{+} \\ {P}_{{f}^{2} {f}^{1} , m - 1}^{+}\end{matrix} ] {{( {P}_{{f}^{1} , m - 1}^{+} )}^{- 1} [ \begin{matrix}{P}_{θ {f}^{1} , m - 1}^{+} \\ {P}_{{f}^{2} {f}^{1} , m - 1}^{+}\end{matrix} ]}^{T} \qquad ( 12 )$$

To improve the convergence of the iterative procedure, a disturbance Q may be added to the posterior covariance matrix at each iteration to provide the prior covariance matrix. Q ∈ [symbol] ⁽ⁿ^{_{θ}}^{+t}^{ₗ}^{×n}^{_{θ}}^{+t}^{ₗ}⁾ is a constant diagonal matrix with small positive diagonal entries.

An explicit presentation of a dynamic model for the covariance matrix of the prediction error, \tilde{R}ₘ may not be available. The following two dynamic models for the statistical parameters of the prior IW distribution may be used, based on a heuristic model.

$${v}_{m}^{-} = ρ ( {v}_{m - 1}^{+} + {n}_{y} + 1 ) - {n}_{y} - 1 \qquad \text{(13-a)}$$

$${V}_{m}^{-} = ρ {V}_{m - 1}^{+} \qquad \text{(13-b)}$$

where ρ∈ (0,1] is a forgetting factor. If ρ=1, Eqs. (13-a) and (13-b) results in a stationary prediction error covariance matrix, while smaller values of ρ allows for larger time variations in the statistical properties of covariance matrix. The mode (most probable) value of the prior IW distribution, considered as prior estimate for \tilde{R}ₘ, is defined as

$${\hat{\tilde{R}}}_{m}^{-} = \frac{{V}_{m}^{-}}{{v}_{m}^{-} + {n}_{y} + 1}$$

while the posterior estimate for \tilde{R}ₘ₋₁ is computed as

$${\hat{\tilde{R}}}_{m - 1}^{+} = \frac{{V}_{m - 1}^{+}}{{v}_{m - 1}^{+} + {n}_{y} + 1} .$$

Based on the dynamic models defined in Eq. (13), it can be concluded that \tilde{\hat{R}}ₘ⁻=\tilde{\hat{R}}ₘ₋₁ ⁺.

Similar to the dynamic model considered for \tilde{R}ₘ, a heuristic model may be considered for propagating the uncertainties of the \tilde{μ}ₘ through time as

$${\hat{\tilde{μ}}}_{m}^{-} = {\hat{\tilde{μ}}}_{m - 1}^{+} \qquad ( 14 a )$$

$${λ}_{m}^{-} = {ρ}^{′} {λ}_{m - 1}^{+} \qquad ( 14 b )$$

where ρ′∈ (0,1] is another forgetting factor. Similar to the case presented for ρ, ρ′ =1 represents a stationary \tilde{μ}ₘ, while smaller values of ρ′ result in larger time variations in the statistical properties of prediction error mean.

### Two-step Marginal MAP Estimation

Posterior estimates of updating parameters ψₘ, \tilde{μ}ₘ, and \tilde{R}ₘ may be found using a maximum a-posteriori (MAP) estimation method. MAP corresponds to the parameters that maximize the joint posterior distribution p(ψₘ, \tilde{μ}ₘ,\tilde{R}ₘ|yₜ_{₁}_{^{m}}_{:t}_{₂}_{^{m}}).

$$\{ {\hat{ψ}}_{m}^{+} , {\hat{\tilde{μ}}}_{m}^{+} , {\hat{\tilde{R}}}_{m}^{+} \} = {arg max}_{{ψ}_{m} , {\tilde{μ}}_{m ,} {\tilde{R}}_{m}} p ( {ψ}_{m} , {\tilde{μ}}_{m ,} {\tilde{R}}_{m} \vert {y}_{{t}_{1}^{m} : {t}_{2}^{m}} ) \qquad ( 15 )$$

The joint posterior distribution p(ψₘ, \tilde{μ}ₘ,\tilde{R}ₘ|yₜ_{₁}_{^{m}}_{:t}_{₂}_{^{m}}) can be factorized into two marginal distributions as follows using the product rule.

$$p ( {ψ}_{m} , {\tilde{μ}}_{m ,} {\tilde{R}}_{m} \vert {y}_{{t}_{1}^{m} : {t}_{2}^{m}} ) = p ( {ψ}_{m} \vert {\tilde{μ}}_{m ,} {\tilde{R}}_{m} , {y}_{{t}_{1}^{m} : {t}_{2}^{m}} ) p ( {\tilde{μ}}_{m ,} {\tilde{R}}_{m} \vert {y}_{{t}_{1}^{m} : {t}_{2}^{m}} ) \qquad ( 16 )$$

Based on the marginal MAP estimation method, the two terms on the right-hand side of Eq. (16) may be maximized separately to find the MAP estimates, i.e.,

$$\{ {\hat{ψ}}_{m}^{+} \} = {arg max}_{{ψ}_{m}} p ( {ψ}_{m} \vert {\tilde{μ}}_{m ,} {\tilde{R}}_{m} , {y}_{{t}_{1}^{m} : {t}_{2}^{m}} ) \qquad ( 17 )$$

$$\{ {\hat{\tilde{μ}}}_{m}^{+} , {\hat{\tilde{R}}}_{m}^{+} \} = {arg max}_{{\tilde{μ}}_{m ,} {\tilde{R}}_{m}} p ( {\tilde{μ}}_{m ,} {\tilde{R}}_{m} \vert {y}_{{t}_{1}^{m} : {t}_{2}^{m}} ) \qquad ( 18 )$$

The correction step in the Bayesian inference formulation may be divided into two separate MAP estimation problems that can be solved iteratively to converge to the MAP estimates of the joint posterior distribution

$$p ( {ψ}_{m} , {\tilde{µ}}_{m} , {\tilde{R}}_{m} \vert {y}_{{t}_{1}^{m} : {t}_{2}^{m}} ) ,$$

as described below.

### Marginal MAP Estimate of ψₘ

The MAP estimation problem in Eq. (17) may be used in non-adaptive Bayesian model updating formulations. Based on the Bayes' theorem, it can be written that

$$p ( {ψ}_{m} \vert {\tilde{μ}}_{m ,} {\tilde{R}}_{m} , {y}_{{t}_{1}^{m} : {t}_{2}^{m}} ) ∝ p ( {y}_{{t}_{1}^{m} : {t}_{2}^{m}} \vert {ψ}_{m} , {\tilde{μ}}_{m ,} {\tilde{R}}_{m} ) p ( {ψ}_{m} \vert {\tilde{μ}}_{m ,} {\tilde{R}}_{m} ) \qquad ( 19 )$$

With both the likelihood and the prior distributions for ψₘ being Gaussian according to Eqs. (3) and (6), respectively, the posterior distribution will also be Gaussian, i.e.,

$$p ( {ψ}_{m} \vert {\tilde{µ}}_{m} , {\tilde{R}}_{m} , {y}_{{t}_{1}^{m} : {t}_{2}^{m}} ) = N ( {ψ}_{m} \vert {\hat{ψ}}_{m}^{+} , {P}_{ψ , m}^{+} ) .$$

The mean vector \hat{ψ}ₘ⁺ (considered the same as the MAP estimate for ψₘ), and the covariance matrix P_{ψ,m}⁺ can be obtained as:

$${\hat{ψ}}_{m}^{+} = {\hat{ψ}}_{m}^{-} + {K}_{m} ( {y}_{{t}_{1}^{m} : {t}_{2}^{m}} - {h}_{{t}_{1}^{m} : {t}_{2}^{m}} ( {\hat{ψ}}_{m}^{-} ) - {\hat{μ}}_{{t}_{1}^{m} : {t}_{2}^{m}}^{+} ) \qquad ( 20 )$$

$${P}_{ψ , m}^{+} = {P}_{ψ , m}^{-} - {K}_{m} {P}_{yy , m} {K}_{m}^{T} \qquad ( 21 )$$

where

$${K}_{m} = {{P}_{ψ y , m} ( {P}_{yy , m} )}^{- 1} , {P}_{ψ y , m} = {{P}_{ψ , m}^{-} ( {C}_{m}^{-} )}^{T} , and {P}_{yy , m} = {C}_{m}^{-} {{P}_{ψ , m}^{-} ( {C}_{m}^{-} )}^{T} + {\hat{R}}_{{t}_{1}^{m} : {t}_{2}^{m}}^{+} .$$

The term

$${C}_{m}^{-} = \frac{\partial {h}_{{t}_{1}^{m} : {t}_{2}^{m}} ( {ψ}_{m} )}{\partial {ψ}_{m}} {\vert}_{{ψ}_{m} = {\hat{ψ}}_{m}^{-}} ∈ {( {n}_{y} \times {t}_{1} ) \times ( {n}_{θ} + {t}_{l} \times {n}_{t} )}^{}$$

is the model response sensitivity matrix with respect to ψₘ at ψₘ=\hat{ψ}ₘ⁻. The terms

$${\hat{µ}}_{{t}_{1}^{m} : {t}_{2}^{m}}^{+} and {\hat{R}}_{{t}_{1}^{m} : {t}_{2}^{m}}^{+}$$

are the posterior estimate of the mean vector and covariance matrix of prediction error. Based on the assumption that they are time-invariant at each estimation window, they can obtain as

$${\hat{μ}}_{{t}_{1}^{m} : {t}_{2}^{m}}^{+} = {[ {( {\hat{\tilde{μ}}}_{m}^{+} )}^{T} , ... , {( {\hat{\tilde{μ}}}_{m}^{+} )}^{T} ]}^{T} ∈ {ℝ}^{( {n}_{y} \times {t}_{1} ) \times 1} \qquad ( 22 - a )$$

$${\hat{R}}_{{t}_{1}^{m} : {t}_{2}^{m}}^{+} = [ \begin{matrix}{\hat{\tilde{R}}}_{m}^{+} & … & 0 \\ ⋮ & ⋱ & ⋮ \\ 0 & … & {\hat{\tilde{R}}}_{m}^{+}\end{matrix} ] ∈ {ℝ}^{( {n}_{y} \times {t}_{1} ) \times ( {n}_{y} \times {t}_{1} )} \qquad ( 22 - b )$$

where \tilde{\hat{μ}}ₘ⁺and \tilde{\hat{R}}ₘ⁺are the MAP estimates of the time-invariant mean vector and covariance matrix of the prediction error at estimation window m; they may be estimated by solving Eq. (18) as described below. Eqs. (20)-(21) are similar to the equations used in the non-adaptive Bayesian model updating methods with the exception of

$${\hat{µ}}_{{t}_{1}^{m} : {t}_{2}^{m}}^{+} ,$$

which is now present in Eq. (20) to account for the non-zero-mean prediction error.
Marginal MAP Estimates of \tilde{μ}ₘ and \tilde{R}ₘ

From Eq. (18), the term

$$p ( {\tilde{µ}}_{m} , {\tilde{R}}_{m} \vert {y}_{{t}_{1}^{m} : {t}_{2}^{m}} )$$

can be written using the Bayes' rule as

$$p ( {\tilde{μ}}_{m} , {\tilde{R}}_{m} \vert {y}_{{t}_{1}^{m} : {t}_{2}^{m}} ) ∝ p ( {y}_{{t}_{1}^{m} : {t}_{2}^{m}} \vert {\tilde{μ}}_{m} , {\tilde{R}}_{m} ) p ( {\tilde{μ}}_{m} , {\tilde{R}}_{m} ) \qquad ( 23 )$$

According to Eq. (7), the prior distribution p(\tilde{μ}ₘ, \tilde{R}ₘ) has a NIW distribution, which is a conjugate prior for the Gaussian likelihood. Therefore, the posterior will also be NIW, i.e.,

$$p ( {\tilde{µ}}_{m} , {\tilde{R}}_{m} \vert {y}_{{t}_{1}^{m} : {t}_{2}^{m}} ) = NIW ( {\tilde{µ}}_{m} , {\tilde{R}}_{m} \vert {\hat{\tilde{µ}}}_{m}^{+} , {λ}_{m}^{+} , {v}_{m}^{+} , {V}_{m}^{+} ) ,$$

with updated parameters \tilde{\hat{μ}}ₘ⁺, λₘ⁺, νₘ⁺, Vₘ⁺.

Based on how the perdition error may be independent across time and the mean vector and covariance matrix of the prediction error are time-invariant at each estimation window, by substituting Eqs. (3) and (7) into Eq. (23), the following updating equations can be derived.

$${\hat{\tilde{μ}}}_{m}^{+} = \frac{{λ}_{m}^{-}}{{t}_{l} + {λ}_{m}^{-}} {\hat{\tilde{μ}}}_{m}^{-} + \frac{{t}_{l}}{{t}_{l} + {λ}_{m}^{-}} {\overline{ω}}_{m} \qquad ( 24 - a )$$

$${λ}_{m}^{+} = {t}_{l} + {λ}_{m}^{-} \qquad ( 24 - b )$$

$${v}_{m}^{+} = {t}_{l} + {v}_{m}^{-} \qquad ( 24 - c )$$

$${V}_{m}^{+} = {V}_{m}^{-} + {\sum }_{k = {t}_{1}^{m}}^{{t}_{2}^{m}} ( {y}_{k} - {h}_{k} ( {\hat{ψ}}_{m}^{+} ) - {\overline{ω}}_{m} ) {( {y}_{k} - {h}_{k} ( {\hat{ψ}}_{m}^{+} ) - {\overline{ω}}_{m} )}^{T} + \frac{{t}_{l} \times {λ}_{m}^{-}}{{t}_{l} + {λ}_{m}^{-}} ( {\overline{ω}}_{m} - {\hat{\tilde{μ}}}_{m}^{-} ) {( {\overline{ω}}_{m} - {\hat{\tilde{μ}}}_{m}^{-} )}^{T} \qquad ( 24 - d )$$

$${\hat{\tilde{R}}}_{m}^{+} = \frac{{V}_{m}^{+}}{{v}_{m}^{+} + {n}_{y} + 1} \qquad ( 24 - e )$$

where

$${\overline{ω}}_{m} = \frac{1}{{t}_{l}} {\sum }_{k = {t}_{1}^{m}}^{{t}_{2}^{m}} ( {y}_{k} - {h}_{k} ( {\hat{ψ}}_{m}^{+} ) )$$

is the average value of prediction error in the estimation window. The mode of the posterior NIW distribution may be selected as the MAP estimates for \tilde{μ}ₘ and \tilde{R}ₘ, i.e., as shown in Eqs. (24-a) and (24-e).

The solution of the MAP estimation problem in Eq. (15) result in solving the coupled Eqs. (20), (24-a), and (24-e) simultaneously using a fixed-point iteration algorithm. First \hat{ψ}ₘ⁺, may be estimated using Eq. (20) given the \tilde{\hat{μ}}ₘ⁺and \tilde{\hat{R}}ₘ⁺obtained from the previous iteration; then μₘ⁺ and Rₘ⁺ may be updated using Eqs. (24-a) and (24-e) based on the estimated \hat{ψ}ₘ⁺, and these estimates may be iterated until convergence is achieved. In a non-limiting example, three convergence criteria can be considered based on relative L2 norm of the difference between two consecutive estimations of \hat{ψ}ₘ⁺, \tilde{\hat{μ}}ₘ⁺and \tilde{\hat{R}}ₘ⁺. A convergence tolerance may be used, such as a convergence tolerance of 0.01. This value can be adjusted by balancing accuracy versus the computational cost. An L2 norm of a matrix is equal to its largest singular value. Table 1 provides a non-limiting example flowchart of a two-step marginal MAP estimation approach.

TABLE 1
Two-step marginal MAP estimation approach for
joint Input, model and noise identification.

Step 1: Set overlap length tₒ, length tₗ, and number N_{w} of estimation windows. Find sliding
rate tₛ, start time t₁^{m}, and end time of t₂^{m} each window.
Set Q, ρ, and ρ′
Set initial values for \hat{ψ}₀⁺, P_{ψ,0}⁺, [symbol] , λ₀⁺, ν₀⁺, and V₀⁺
Step 2: For each estimation window m (m = 1, 2, . . . , N_{w})
Prediction step:
Find \hat{ψ}ₘ⁻ and \hat{P}_{ψ,m}⁻ from the previous estimation window using Eqs (10) and (11),
and set \hat{ψ}_{m,0}⁺ = \hat{ψ}ₘ⁻ [symbol]
= [symbol]
λₘ⁻ = ρ′λₘ⁺
νₘ⁻ = ρ(νₘ⁺ + n_{y} + 1) − n_{y} − 1
Vₘ⁻ = ρVₘ⁺
Correction step:
Correct the scalar parameters of NIW distribution as follows.

```
  λₘ⁺ = tₗ + λₘ⁻
  vₘ⁺ = tₗ + vₘ⁻
Iterate (i = 1, 2, . . .)
  \hat{Ψ}_{m,i}⁻ = \hat{Ψ}_{m,i-1}⁺
    Run the model with \hat{Ψ}_{m,i}⁻ to find response vector, hₜ_{₁}_{^{m}}_{:t}_{₂}_{^{m}}(\hat{Ψ}_{m,i}⁻), and then calculate response
    sensitivity matrix C_{m,i}⁻.
  ${\hat{Ψ}}_{m}^{+ ( 0 )} = {\hat{Ψ}}_{m , i}^{-} , {\hat{\tilde{μ}}}_{m}^{+ ( 0 )} + {\hat{\tilde{μ}}}_{m}^{-} , {V}_{m}^{+ ( 0 )} = {V}_{m}^{-} , {\hat{\tilde{R}}}_{m}^{+ ( 0 )} = \frac{{v}_{m}^{+ ( 0 )}}{{v}_{m}^{+} + {n}_{y} + 1}$
  P_{Ψy,m} = P_{Ψ,m}⁻(Cₘ⁻)^{T}
  Lₘ⁻ = C_{m,i}⁻P_{Ψ,m}⁻(C_{m,i}⁻)^{T}
    Iterate (j = 0, 1, . . .):
      ${\hat{R}}_{{t}_{1}^{m} : {t}_{2}^{m}}^{+ ( j )} = [ \begin{matrix}{\hat{\tilde{R}}}_{m}^{+ ( j )} & ⋯ & 0 \\ ⋮ & ⋱ & ⋮ \\ 0 & ⋯ & {\hat{\tilde{R}}}_{m}^{+ ( j )}\end{matrix} ]$
      ${P}_{yy , m}^{( j )} = {L}_{m}^{-} + {\hat{R}}_{{t}_{1}^{m} : {t}_{2}^{m}}^{+ ( j )}$
      Kₘ^{(j)} = P_{Ψy,m} (P_{yy,m}^{(j)})⁻¹
      ${\hat{µ}}_{{t}_{1}^{m} : {t}_{2}^{m}}^{+ ( j )} = {[ {\hat{\tilde{µ}}}_{m}^{+ ( j )} , … , {\hat{\tilde{µ}}}_{m}^{+ ( j )} ]}^{T}$
      ${\hat{Ψ}}_{m}^{+ ( j + 1 )} = {\hat{Ψ}}_{m , i}^{-} + {K}_{m}^{( j )} ( {y}_{{t}_{1}^{m} : {t}_{2}^{m}} - {h}_{{t}_{1}^{m} : {t}_{2}^{m}} ( {\hat{Ψ}}_{m , i}^{-} ) - {\hat{µ}}_{{t}_{1}^{m} : {t}_{2}^{m}}^{+ ( j )} )$
        $Run model with {\hat{Ψ}}_{m}^{+ ( j + 1 )} to find response vector {h}_{{t}_{1}^{m} : {t}_{2}^{m}} ( {\hat{Ψ}}_{m}^{+ ( j + 1 )} ) .$
      ${\overline{ω}}_{m} = \frac{1}{{t}_{l}} {\sum }_{k = {t}_{1}^{m}}^{{t}_{2}^{m}} ( {y}_{k} - {h}_{k} ( {\hat{Ψ}}_{m}^{+ ( j + 1 )} ) )$
      ${\hat{\tilde{μ}}}_{m}^{+ ( j + 1 )} = \frac{{λ}_{m}^{-}}{{t}_{l} + {λ}_{m}^{-}} {\hat{\tilde{μ}}}_{m}^{-} + \frac{{t}_{l}}{{t}_{l} + {λ}_{m}^{-}} {\overline{ω}}_{m}$
      ${V}_{m}^{+ ( j + 1 )} = {V}_{m}^{-} + {\sum }_{k = {t}_{1}^{m}}^{{t}_{2}^{m}} ( {y}_{k} - {h}_{k} ( {\hat{Ψ}}_{m}^{+ ( j + 1 )} ) - {\overline{ω}}_{m} ) {( {y}_{k} - {h}_{k} ( {\hat{Ψ}}_{m}^{+ ( j + 1 )} ) - {\overline{ω}}_{m} )}^{T} + \frac{{t}_{l} \times {λ}_{m}^{-}}{{t}_{l} + {λ}_{m}^{-}} ( {\overline{ω}}_{m} - {\hat{\tilde{μ}}}_{m}^{-} ) {( {\overline{ω}}_{m} - {\hat{\tilde{μ}}}_{m}^{-} )}^{T}$
      ${\hat{\tilde{R}}}_{m}^{+ ( j + 1 )} = \frac{{v}_{m}^{+ ( j + 1 )}}{{v}_{m}^{+} + {n}_{y} + 1}$
      $Check for j loop convergenc : If \frac{‖ {\hat{Ψ}}_{m}^{+ ( j + 1 )} - {\hat{Ψ}}_{m}^{+ ( j )} ‖}{‖ {\hat{Ψ}}_{m}^{+ ( j )} ‖} < 0.01 , \frac{‖ {\hat{\tilde{μ}}}_{m}^{+ ( j + 1 )} - {\hat{\tilde{μ}}}_{m}^{+ ( j )} ‖}{‖ {\hat{\tilde{μ}}}_{m}^{+ ( j )} ‖} < 0.01 , and$
      $\frac{‖ {\hat{\tilde{R}}}_{m}^{+ ( j + 1 )} - {\hat{\tilde{R}}}_{m}^{+ ( j )} ‖}{‖ {\hat{\tilde{μ}}}_{m}^{+ ( j )} ‖} < 0.01 , then set {\hat{Ψ}}_{m , i}^{+} = {\hat{Ψ}}_{m}^{+ ( j )} , {\hat{\tilde{μ}}}_{m}^{+} = {\hat{\tilde{μ}}}_{m}^{+ ( j )} ,$
      Vₘ⁺ = Vₘ^{+(j)}, find P_{Ψ,m}⁺ = P_{Ψ,m}⁺ = P_{Ψ,m}⁻ − Kₘ^{(j)}P_{yy,m}^{(j)}(Kₘ^{(j)})^{T}, and move to the next i
      iteration loop; otherwise, j = j + 1 and iterate again.
    $Check for i loop convergence : If \frac{‖ {\hat{Ψ}}_{m , i}^{+} - {\hat{Ψ}}_{m , i - 1}^{+} ‖}{‖ {\hat{Ψ}}_{m , i - 1}^{+} ‖} < 0.01 , then set {\hat{Ψ}}_{m}^{+} = {\hat{Ψ}}_{m , i}^{+} , and$
    move to the next estimation window m + 1; otherwise, i = i + 1 and iterate again.
```

Non-limiting Example Verification: 3-story 1-bay Steel Moment Frame

### Model Description and Data Simulation

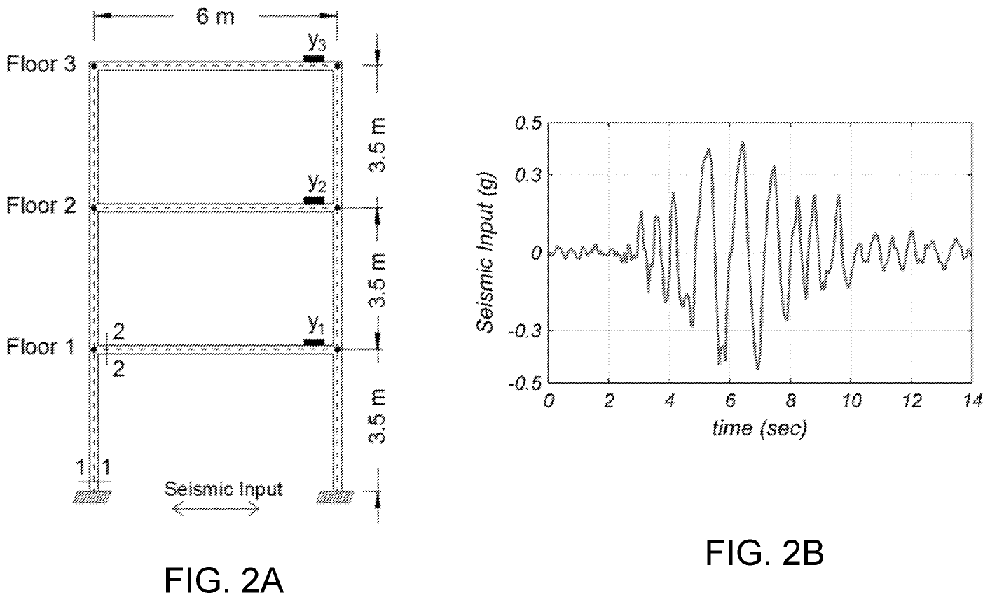

Referring to FIGS. 2A and 2B, a non-limiting example 3-story 1-bay steel moment frame is shown in FIG. 2A, and a ground acceleration time history of 1989 Loma Prieta earthquake recorded at Los Gatos station in the 0° component is shown in FIG. 2B. Performance of the Bayesian inference framework for joint estimation of model parameters and noise (noise or prediction error=modeling error+measurement noise) may be evaluated with the nonlinear model of a 3-story 1-bay steel moment frame under earthquake excitation as shown in FIGS. 2A and 2B. A 2D nonlinear FE model of the structure was developed in the open-source FE analysis platform OpenSees. Columns are made of A992 steel with W14×311 cross-section and beams were made of A36 steel with W24×68 cross-section. Nodal mass of 80 metric tons was considered at beam-column nodes shown. Columns and beams were modeled using force-based beam-column elements with fiber sections. Seven integration points were considered for numerical integration along the length of each element using Gauss-Lobatto quadrature rule. Column and beam webs were discretized into 10 fibers along height and one fiber across width. Their flanges were also discretized into one fiber along height and 3 fibers along width. The uniaxial material model for steel fibers was based on the Giuffre-Menegotto-Pinto (GMP) constitutive model. Rayleigh damping was considered to model the structural damping assuming 2% damping ratio for the first two modes.

The 1989 Loma Prieta earthquake (0° component at Los Gatos station) was selected as the base excitation as illustrated. The horizontal absolute acceleration response time histories at each floor (referred to as true/nominal responses and denoted by y true) were simulated and contaminated with measurement noise to represent the sensor measurements (denoted by y). The measurement locations are shown. The measurement noise was considered as a non-stationary Gaussian random process with time-variant mean vector and covariance matrix denoted by μₖ^{true} and Rₖ^{true}, respectively. The measurement noises were assumed statistically uncorrelated; therefore, the off-diagonal entries of Rₖ^{true} at each time step k were equal to zero. Sine functions were considered to model variation of μₖ^{true} and the diagonal entries of Rₖ^{true} in time.

$${μ}_{k}^{true} = {\tilde{μ}}^{noise} sin ( \frac{4 π}{N} k ) \qquad ( 25 )$$

$$diag ( {R}_{k}^{true} ) = {{\tilde{r}}^{noise} ( sin ( \frac{π}{N} k ) + 1 )}^{2} \qquad ( 26 )$$

where N is the number of time steps, and are constant μ^{noise} and i^{noise} coefficient vectors and defined as follows.

$$\begin{matrix}( 27 ) & \\ {\tilde{μ}}^{noise} = 50 \times mean ( {y}^{true} ) = {[ 1.97 , 5.41 , 7.5 ]}^{T} \times {10}^{- 2} g & ( 25 )\end{matrix}$$

$${\tilde{r}}^{noise} = {( 0.1 \times RMS ( {y}^{true} ) )}^{2} = {[ 1.66 , 2.88 , 7.65 ]}^{T} \times {10}^{- 4} {g}^{2} \qquad ( 28 )$$

Three parameters of the GMP model for beams and columns were considered as the unknown (updating) model parameters, including the Young's modulus E, yield stress σ_{y}, and strain-hardening ratio b. The parameters were specified by subscripts b and c for beams and columns, respectively. The nominal (or true) values of these parameters used for simulation are reported in Table 2. The mass and stiffness proportional components of Rayleigh damping, i.e., α and β, respectively, were also considered as the unknown model parameters to be estimated. Their true or nominal values were considered as α^{true}=0.1718 s⁻¹ and β^{true}=0.0014 s. Therefore, the unknown model parameter vector θ included 8 parameters, each one was normalized by its true value, i.e.,

$$θ = {[ \begin{matrix}{E}_{c} / {E}_{c}^{true} & {σ}_{yc} / {σ}_{yc}^{true} & {b}_{c} / {b}_{c}^{true} & {E}_{b} / {E}_{b}^{true} & {σ}_{yb} / {σ}_{yb}^{true} & {b}_{b} / {b}_{b}^{true} & α / {α}^{true} & β / {β}^{true}\end{matrix} ]}^{T}$$

TABLE 2
True/nominal values of the three parameters of GMP model
for columns and beams used for measurement simulations.

| | E^{true} (GPa) | σ_{y}^{true} (MPa) | b^{true} |
|---|---|---|---|
| Columns | 200 | 350 | 0.08 |
| Beams | 200 | 250 | 0.05 |

### Identification Results

The methods in accordance with the present disclosure were applied to estimate the unknown model parameter vector θ together with the mean vector and covariance matrix of prediction error. The initial value of θ was selected as θ′₀⁺=[0.7 0.7 1.2 0.8 1.3 0.8 1.2 0.7]^{T} with the initial covariance matrix P_{θ,0}⁺=diag (0.2 θ₀⁺)², i.e., a 20% initial coefficient of variation (COV) was considered to characterize the prior covariance matrix. The process noise covariance matrix was assumed as Q=diag (10⁻⁴ \hat{θ}₀⁺)² and the forgetting factor parameters are selected as ρ=0.95 and ρ′=0.95. The initial mean vector and covariance matrix of the prediction error were assumed as \hat{μ}₀⁺=0 and \hat{R}₀⁺=diag (r^{noise})/100 respectively, where \tilde{r}^{noise} is defined in Eq. (26). Other initial parameters considered for the NIW distribution are λ₀⁺=1, ν₀⁺=4.1, and V₀⁺=(v₀⁺+n_{y}+1)\hat{R}₀⁺ with n_{y}=3. In this verification study, the results of the proposed joint model and noise identification method is compared with a classic non-adaptive recursive Bayesian method (Ebrahimian et al. 2015), in which the prediction error ωₖ is assumed to be an independent zero-mean Gaussian white noise with a time-invariant diagonal covariance matrix, i.e., ωₖ˜N (0, Rₖ=\hat{R}₀⁺)

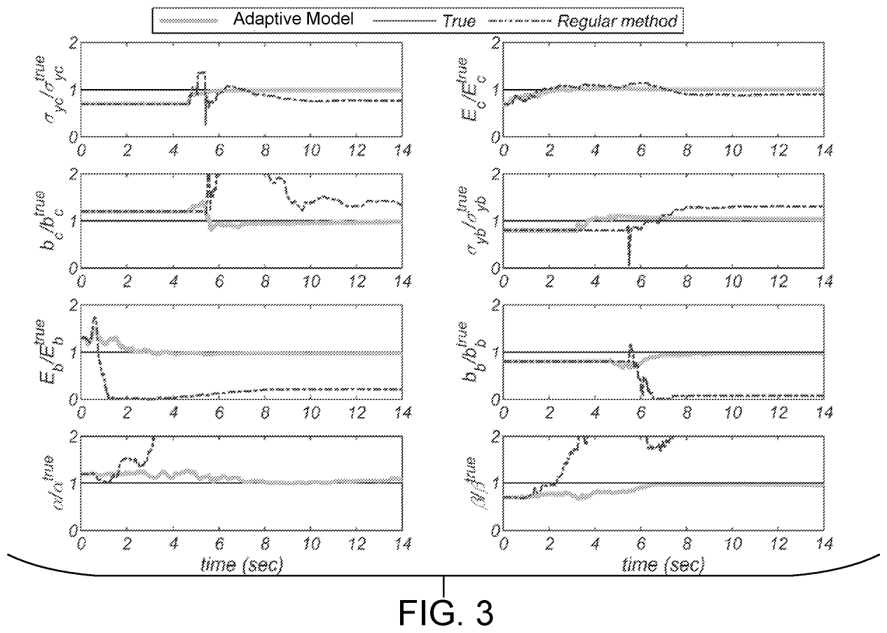

Referring to FIG. 3, graphs of non-limiting example estimated model parameters for both methods of FIGS. 2A and 2B are shown. The Bayesian method can estimate accurately all 8 unknown model parameters, while model parameter estimates are biased or incorrect for the non-adaptive Bayesian model updating method. The non-adaptive Bayesian model updating method can even result in divergence of the model updating process or producing nonphysical model parameter estimates, e.g., zero estimated values for E_{b}.

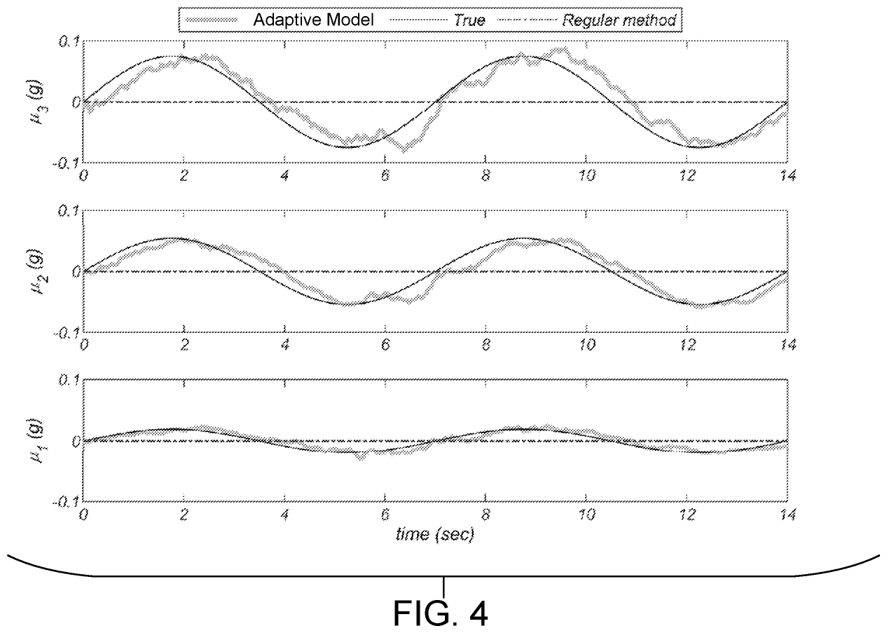

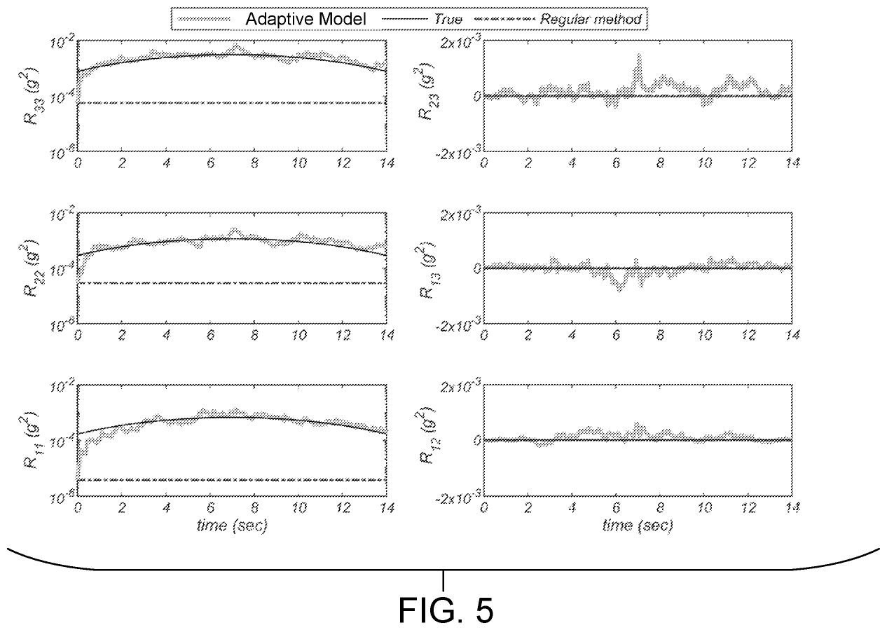

Referring to FIG. 4 and FIG. 5, graphs of non-limiting example estimated mean and covariance of the prediction error are shown, respectively, at each time step. It can be seen that the Bayesian method accurately tracks the trend of the true mean vector and covariance matrix in time.

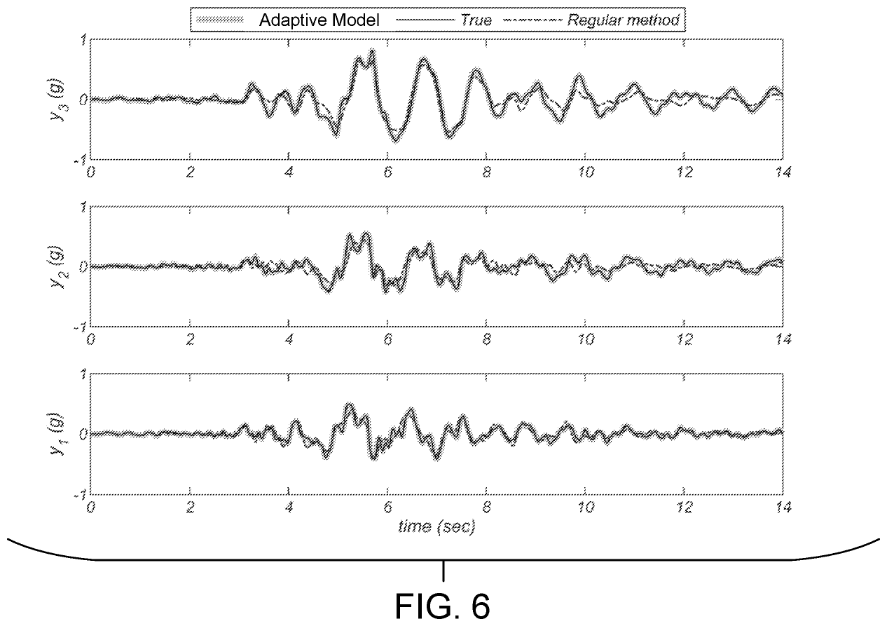

Referring to FIG. 6, graphs of estimated absolute acceleration responses at each floor—using the final estimated model parameters—are compared with the true/nominal counterparts. The noticeable discrepancies between the estimated and nominal responses for the non-adaptive Bayesian model updating method, which is due to the biased model parameter estimates, clearly show the incapability of the non-adaptive Bayesian model updating method to perform in the presence of a time-varying prediction error. The acceleration responses predicted using the joint model and noise identification method match the nominal responses well.

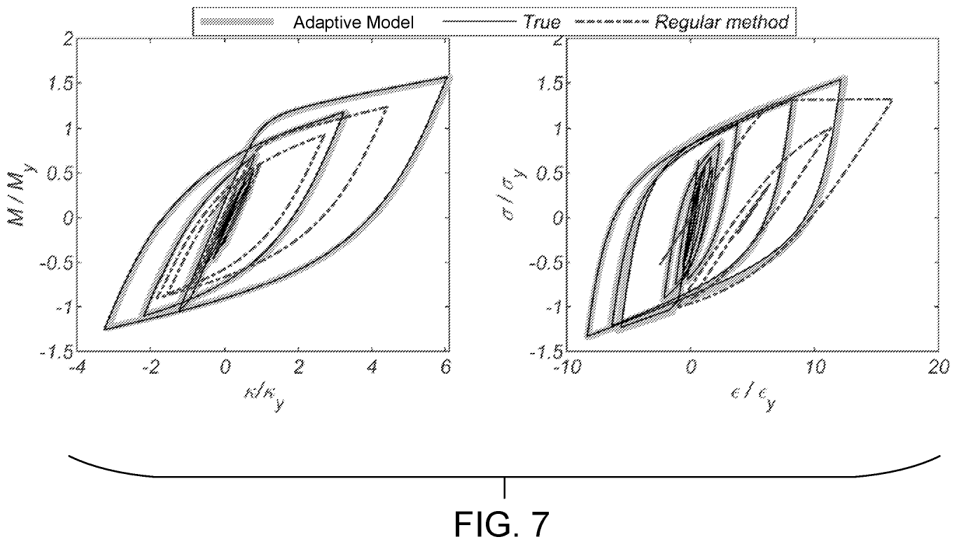

Referring to FIG. 7, graphs of the moment-curvature response at the base section of the left column—Section 1-1 in FIG. 2A—and the stress-strain response of the top flange of the first-floor beam at the plastic hinge location—Section 2-2 in FIG. 2A—are shown and were estimated from the updated models using the non-adaptive and adaptive model updating methods. The detrimental effects of the time-varying noise in the response prediction and virtual sensing capability of the non-adaptive Bayesian model updating may be seen. The adaptive Bayesian model can handle the time-varying noise effects and provide accurate virtual sensing capability.

Non-limiting examples have been provided of an adaptive recursive Bayesian inference framework for joint model and noise identification using a two-step marginal maximum a posteriori (MAP) estimation approach. Noise or prediction error can include the measurement noise and the effects of modeling error. Non-limiting example separate MAP estimation problems may be solved iteratively: one to estimate the unknown model parameters and another to estimate the mean vector and covariance matrix of the prediction error. Verification of a non-limiting example included using numerically simulated data obtained from a nonlinear steel moment frame model subjected to earthquake excitation. The absolute acceleration responses at each floor were simulated and polluted by a non-stationary Gaussian noise with time-variant mean vector and covariance matrix. Eight model parameters, including six parameters characterizing the constitutive models of the beams and columns steel material, and two Rayleigh damping coefficients, were considered as unknown and estimated using the proposed approach and a non-adaptive recursive Bayesian model updating approach for comparison. The non-limiting example verification demonstrated the detrimental effects of time-varying noise on the non-adaptive Bayesian model updating results, where the estimated model parameters were significantly biased.

An adaptive or recursive Bayesian inference framework for joint model and noise identification was able to estimate the model parameters correctly, due to its capability to estimate the time-variant mean and covariance of the prediction error. Considering the statistical characteristics of prediction error as unknowns to be estimated provides additional degrees of freedom in the recursive Bayesian model updating approach and can alleviate the biased or incorrect model parameter estimation results. The method can provide a step-forward to account for the effects of modeling error in finite element model updating.

Another non-limiting example can include estimating both the unknown model parameters and statistical characteristics (mean vector and covariance matrix) of the prediction error, as well an approximation of their joint posterior distribution. Exact calculation of this high-dimensional joint posterior distribution is intractable, so the process requires approximation. Two approximation schemes can be used: stochastic or sampling methods such as, for example, Markov chain Monte Carlo (MCMC), and deterministic or variational frameworks such as, for example, variational Bayesian (VB). In comparison to the sampling methods, the VB method is analytically tractable and is computationally less demanding. The VB method has been successfully applied for joint state and noise estimation in navigation, target tracking, and control related applications. In these applications, adaptive VB Kalman filter method was used to estimate jointly the covariance matrix of a zero-mean prediction error and the state of linear or nonlinear state-space models. The VB method assumes that the approximate joint distribution is the product of some single-or multi-variable factors and uses the Kullback-Leibler (KL) divergence to minimize the difference between the approximation and the true posterior.

Continuing, another non-limiting example can provide an adaptive method for nonlinear model updating based on the VB method to approximate the joint posterior distribution of the unknown model parameters and statistical characteristics of the prediction error at each time step.

Below, a model updating problem statement and a detailed derivation of the proposed VB method for estimating the joint posterior distribution of unknown model parameters and statistical characteristics of the prediction error are provided. Further, the formulation of the VB method is then compared with the two-step marginal MAP estimation method, and then the proposed method is verified using a 3-story 1-bay nonlinear steel moment frame under earthquake excitation, and the results are compared to those from the two-step marginal MAP estimation method provided above and a non-adaptive Bayesian model updating method.

### Model Updating Problem Statement

Consider the measured response of a nonlinear (or linear) dynamic system y, and its corresponding model (e.g., finite element (FE)) prediction h(θ) where θ is the vector of unknown model parameters. The parameter estimation problem at time k=1, 2, . . . , N can be formulated as

$${θ}_{k} = {θ}_{k - 1} + {γ}_{k - 1} \qquad ( 1 )$$

$${y}_{k} = h ( {θ}_{k} ) + {ω}_{k} \qquad ( 2 )$$

where γₖ₋₁ is the process noise and ωₖ is the prediction error. The input forces are assumed to be known, so for the sake of notation brevity the dependency of model prediction response to the input forces is not shown explicitly in Eq. (2). The process noise is assumed to follow a zero-mean Gaussian white noise process with covariance matrix Q, i.e., γₖ₋₁˜N(0, Q). In non-adaptive Bayesian model updating methods, the prediction error is assumed as a zero-mean Gaussian white noise process with a constant or time-invariant covariance matrix R, i.e., ωₖ˜N (0, R). For the parameter estimation problem defined in Eqs. (1) and (2), the non-adaptive Bayesian methods can be used to find an estimate for the first two statistical moments of unknown model parameters. However, in the adaptive Bayesian model updating methods, the prediction error can be modeled as a non-stationary Gaussian random process with unknown and time-variant mean vector μₖ and covariance matrix Rₖ, i.e., ωₖ˜N (μₖ, Rₖ), to be estimated recursively and jointly with the unknown vector of model parameters θₖ. As discussed above, a two-step maximum a posteriori (MAP) estimation method was used to estimate θₖ, μₖ, and Rₖby maximizing the joint posterior distribution p(θₖ, μₖ, Rₖ|y_{1:k}), i.e.,

$$\{ {\hat{θ}}_{k} , {\hat{μ}}_{k} , {\hat{R}}_{k} \} = {arg max}_{{θ}_{k} , {μ}_{k} , {R}_{k}} p ( {θ}_{k} , {μ}_{k} , {R}_{k} \vert {y}_{1 : k} ) \qquad ( 3 )$$

To solve this MAP problem, the problem was broken into two iterative MAP estimation problems as

$$\{ {\hat{θ}}_{k} \} = {argmax}_{{θ}_{k}} p ( {θ}_{k} \vert {µ}_{k} , {R}_{k} , {y}_{1 : k} ) and \{ {\hat{µ}}_{k} , {\hat{R}}_{k} \} = {argmax}_{{µ}_{k} , {R}_{k}} p ( {µ}_{k} , {R}_{k} \vert {y}_{1 : k} ) .$$

An example aim of this method is to find the whole joint posterior distribution of unknown model parameters and noise p(θₖ, μₖ, Rₖ|y_{1:k}). Nevertheless, analytical working with this joint posterior distribution is difficult because the number of variables is high, and the joint distribution is highly complex. To overcome this issue, the VB method is used to approximate the joint posterior distribution. The VB method and the derivation details are provided below.

### Variational Bayesian (VB) Method

VB is a method to approximate a joint distribution p by a joint distribution Q which can be factorized into single-variable or grouped-variables factors. The Kullback-Leibler (KL) divergence criterion is then used to make Q as close as possible to p. Using the VB method, the joint posterior distribution of the unknown model parameters and prediction error mean vector and covariance matrix are estimated by separating the joint posterior distribution into two factors as follows,

$$p ( {θ}_{k} , {μ}_{k} , {R}_{k} \vert {y}_{1 : k} ) \approx {Q}_{θ} ( {θ}_{k} ) {Q}_{μ , R} ( {μ}_{k} , {R}_{k} ) \qquad ( 4 )$$

where Q_{θ}(θₖ) and Q_{μ,R}(μₖ, Rₖ) are unknown distributions which can be obtained by minimizing the KL divergence between the right-and left-hand side of Eq. (4). The KL divergence is defined as

$$KL ( {Q}_{θ} ( {θ}_{k} ) {Q}_{μ , R} ( {μ}_{k} , {R}_{k} ) ‖ p ( {θ}_{k} , {μ}_{k} , {R}_{k} \vert {y}_{1 : k} ) ) = \int {Q}_{θ} ( {θ}_{k} ) {Q}_{μ , R} ( {μ}_{k} , {R}_{k} ) ln ( \frac{{Q}_{θ} ( {θ}_{k} ) {Q}_{μ , R} ( {μ}_{k} , {R}_{k} )}{p ( {θ}_{k} , {μ}_{k} , {R}_{k} \vert {y}_{1 : k} )} ) d {θ}_{k} d {μ}_{k} {dR}_{k} \qquad ( 5 )$$

Using variational calculus to minimize the above KL-divergence with respect to each of Q_{θ}(θₖ) and Q_{μ,R}(μₖ, Rₖ) while keeping the other one fixed will result in Eqs. (6) and (7).

$${Q}_{θ} ( {θ}_{k} ) = {c}_{θ} exp ( {E}_{{θ}_{k} , {R}_{k}} [ ln ( p ( {y}_{1 : k} , {θ}_{k} , {μ}_{k} , {R}_{k} ) ) ] ) \qquad ( 6 )$$

$${Q}_{μ , R} ( {μ}_{k} , {R}_{k} ) = {c}_{μ , R} exp ( {E}_{{θ}_{k}} [ ln ( p ( {y}_{1 : k} , {θ}_{k} , {μ}_{k} , {R}_{k} ) ) ] ) \qquad ( 7 )$$

where Eₓ[f(x)] denotes the expected value of f(x) with respect to x with probability density function of p(x), i.e., Eₓ[f(x)]=∫f(x)p(x)dx. The terms c_{θ} and c_{μ,R} denote the constants with respect to variables θₖ and {μₖ, Rₖ}, respectively. Since Eqs. (6) and (7) are coupled through the term p(y_{1:k}, θₖ, μₖ, Rₖ), analytical solutions are not available. Therefore, the fixed-point iteration algorithm can be employed to find approximate solutions for Eqs. (6) and (7). To this end, the right-hand sides of Eqs. (6) and (7) are expanded from their innermost parentheses to the outer through the following steps.

The joint distribution p(y_{1:k}, θₖ, μₖ, Rₖ) in Eqs. (6) and (7) can be factored as,

$$p ( {y}_{1 : k} , {θ}_{k} , {μ}_{k} , {R}_{k} ) = p ( {y}_{k} \vert {θ}_{k} , {μ}_{k} , {R}_{k} , {y}_{1 : k - 1} ) p ( {θ}_{k} \vert {μ}_{k} , {R}_{k} , {y}_{1 : k - 1} ) p ( {μ}_{k} , {R}_{k} \vert {y}_{1 : k - 1} ) p ( {y}_{1 : k - 1} ) \qquad ( 8 )$$

where p(yₖ|θₖ, μₖ, Rₖ, y_{1:k-1}) is the likelihood function, p(θₖ|μₖ, Rₖ, y_{1:k-1}) is the prior distribution of θₖ, p(μₖ, Rₖ|y_{1:k-1}) is the prior joint distribution of μₖ and Rₖ, and p(y_{1:k-1}) is known because it depends on the past measurements.

Based on Eq. (2), and further expansion of the terms on the right-hand-side of Eq. (8), the likelihood function p(yₖ|θₖ, μₖ, Rₖ, y_{1:k-1}) has a Gaussian distribution as

$$p ( {y}_{k} \vert {θ}_{k} , {μ}_{k} , {R}_{k} , {y}_{1 : k - 1} ) = p ( {ω}_{k} ) = N ( {ω}_{k} \vert {μ}_{k} , {R}_{k} ) \qquad ( 9 )$$

For the second and third terms on the right-hand-side of Eq. (8), it is assumed, similar to method described above that θₖ and {μₖ, Rₖ} have prior distributions of Gaussian and Normal-Inverse-Wishart (NIW), respectively. NIW distribution is the product of a Gaussian (or Normal) distribution and an Inverse-Wishart (IW). The NIW is selected for the prior distribution p(μₖ, Rₖ, y_{1:k-1}) because it is a conjugate prior for a Gaussian likelihood with unknown mean vector and covariance matrix. The conjugacy guarantees the same functional form for the posterior and prior distributions (O'Hagan and Forster 2004). Therefore, the second and third terms on the right-hand-side of Eq. (8) can be written as follows.

$$p ( {θ}_{k} \vert {μ}_{k} , {R}_{k} , {y}_{1 : k - 1} ) = N ( {θ}_{k} \vert {\hat{θ}}_{k}^{-} , {P}_{θ , k}^{-} ) \qquad ( 10 )$$

$$\begin{matrix}p ( {μ}_{k} , {R}_{k} \vert {y}_{1 : k - 1} ) = NIW ( {μ}_{k} , {R}_{k} \vert {\hat{μ}}_{k}^{-} , {λ}_{k}^{-} , {v}_{k}^{-} , {V}_{k}^{-} ) \\ = N ( {μ}_{k} \vert {\hat{μ}}_{k}^{-} , \frac{{R}_{k}}{{λ}_{k}^{-}} ) \times IW ( {R}_{k} \vert {v}_{k}^{-} , {V}_{k}^{-} )\end{matrix} \qquad ( 11 )$$

where \hat{θ}ₖ⁻ and P_{θ,k}⁻ are the mean vector and covariance matrix of the unknown model parameters θₖ given measurements y_{1:k-1} but not yₖ. The minus superscripts represent the prior estimates \hat{μ}ₖ⁻, λₖ⁻, νₖ⁻ and Vₖ⁻ are the prior estimates of statistical parameters used in the NIW distribution. \hat{μ}ₖ⁻ is the prior estimate for μₖ, and Vₖ⁻ is symmetric positive definite scale matrix. λₖ⁻ and νₖ⁻ are the confidence parameter and the degree of freedom parameter, respectively. They are scalar parameters and shall satisfy λₖ⁻>0 and νₖ^{->n}_{y}−1 where n_{y} is the number of measurement sensors.

By substituting Eqs. (9), (10) and (11) into Eq. (8), it can be followed that

$$p ( {y}_{1 : k} , {θ}_{k} , {μ}_{k} , {R}_{k} ) = N ( {ω}_{k} \vert {μ}_{k} , {R}_{k} ) N ( {θ}_{k} \vert {\hat{θ}}_{k}^{-} , {P}_{θ , k}^{-} ) N ( {μ}_{k} \vert {\hat{μ}}_{k}^{-} , \frac{{R}_{k}}{{λ}_{k}^{-}} ) IW ( {R}_{k} \vert {v}_{k}^{-} , {V}_{k}^{-} ) p ( {y}_{1 : k - 1} ) \qquad ( 12 )$$

The Gaussian (or Normal) distribution and the Inverse-Wishart (IW) distribution are proportional to the following expressions.

$$N ( x \vert μ , Σ ) ∝ {\vert Σ \vert}^{- 1 / 2} exp ( - \frac{1}{2} {( x - μ )}^{T} {Σ}^{- 1} ( x - μ ) ) \qquad ( 13 - a )$$

$$IW ( Σ \vert v , V ) ∝ {\vert Σ \vert}^{- ( v + {n}_{y} + 1 ) / 2} exp ( - \frac{1}{2} tr ( V {Σ}^{- 1} ) ) \qquad ( 13 - b )$$

where |.| represents determinant and tr(.) denotes trace of a matrix. The sign “∝” representing “proportional to” is used in Eq. (13), as the normalizing terms are ignored.

Using Eq. (12) and the definitions of Normal and IW distributions in Eq. (13), the term ln(p(y_{1:k}, θₖ, μₖ, Rₖ)), which is used in Eqs. (6) and (7), can be expanded as follows.

$$ln ( p ( {y}_{1 : k} , {θ}_{k} , {μ}_{k} , {R}_{k} ) ) = - \frac{1}{2} ln ( \vert {R}_{k} \vert ) - \frac{1}{2} {( {y}_{k} - {h}_{k} ( {θ}_{k} ) - {μ}_{k} )}^{T} {R}_{k}^{- 1} ( {y}_{k} - {h}_{k} ( {θ}_{k} ) - {μ}_{k} ) - \frac{1}{2} ln ( \vert {P}_{θ , k}^{-} \vert ) - \frac{1}{2} {( {θ}_{k} - {\hat{θ}}_{k}^{-} )}^{T} {( {P}_{θ , k}^{-} )}^{- 1} ( {θ}_{k} - {\hat{θ}}_{k}^{-} ) - \frac{1}{2} ln ( \vert \frac{{R}_{k}}{{λ}_{k}^{-}} \vert ) - \frac{1}{2} {( {μ}_{k} - {\hat{μ}}_{k} )}^{T} {( \frac{{R}_{k}}{{λ}_{k}^{-}} )}^{- 1} ( {μ}_{k} - {\hat{μ}}_{k}^{-} ) - \frac{{v}_{k}^{-} + {n}_{y} + 1}{2} ln ( \vert {R}_{k} \vert ) \frac{1}{2} tr ( {V}_{k}^{-} {R}_{k}^{- 1} ) + {c}_{θ , μ , R} \qquad ( 14 )$$

where c_{θ, μ, R} denotes a constant with respect to all variables θₖ, μₖ, and Rₖ. Now, having the expansion of ln(p(y_{1:k}, θₖ, μₖ, Rₖ)) in Eq. (14), the expectation terms in Eqs. (6) and (7) can be calculated. By getting the expectation from each term of Eq. (14), the expectation term in Eq. (6), E_{μ}_{_{k,}} _{R}_{ₖ}[ln (p(y_{1:k}, θₖ, μₖ, Rₖ))], can be expressed as follows.

$${E}_{{μ}_{k} , {R}_{k}} [ ln ( p ( {y}_{1 : k} , {θ}_{k} , {μ}_{k} , {R}_{k} ) ) ] == - \frac{1}{2} {E}_{{μ}_{k} , {R}_{k}} [ {( {y}_{k} - {h}_{k} ( {θ}_{k} ) - {μ}_{k} )}^{T} {R}_{k}^{- 1} ( {y}_{k} - {h}_{k} ( {θ}_{k} ) - {μ}_{k} ) ] - \frac{1}{2} {( {θ}_{k} - {\hat{θ}}_{k}^{-} )}^{T} {( {P}_{θ , k}^{-} )}^{- 1} ( {θ}_{k} - {\hat{θ}}_{k}^{-} ) + {c}_{θ} \qquad ( 15 )$$

where c_{θ} is the summation of expectations of all terms in the right-hand side of Eq. (14) except the second and fourth terms and is constant with respect to θₖ. Note that the expectation of the fourth term of Eq. (14) is equal to itself because it does not depend on μₖ, and Rₖ.

Using Lemma 1 in the Appendix (provided below), the expectation term in Eq. (15) can be evaluated as

$$\begin{matrix}\begin{matrix}{E}_{{μ}_{k} , {R}_{k}} [ {( {y}_{k} - {h}_{k} ( {θ}_{k} ) - {μ}_{k} )}^{T} \\ {R}_{k}^{- 1} ( {y}_{k} - {h}_{k} ( {θ}_{k} ) - {μ}_{k} ) ]\end{matrix} = {E}_{{R}_{k}} [ {E}_{{μ}_{k}} [ {( {y}_{k} - {h}_{k} ( {θ}_{k} ) - {μ}_{k} )}^{T} \\ {R}_{k}^{- 1} ( {y}_{k} - {h}_{k} ( {θ}_{k} ) - {μ}_{k} ) ] ] \\ = {E}_{{R}_{k}} [ {( {y}_{k} - {h}_{k} ( {θ}_{k} ) - {E}_{{μ}_{k}} [ {μ}_{k} ] )}^{T} \\ {R}_{k}^{- 1} ( {y}_{k} - {h}_{k} ( {θ}_{k} ) - {E}_{{μ}_{k}} [ {μ}_{k} ] ) + \\ tr ( {R}_{k}^{- 1} \times {cov}_{{μ}_{k}} ( {μ}_{k} ) ) ]\end{matrix} \qquad ( 16 )$$

Now, consider Q_{μ,R}(μₖ, Rₖ) as a NIW distribution, i.e.,

$${Q}_{μ , R} ( {μ}_{k} , {R}_{k} ) = N ( {μ}_{k} \vert {\hat{μ}}_{k}^{+} , \frac{{R}_{k}}{{λ}_{k}^{+}} ) IW ( {R}_{k} \vert {v}_{k}^{+} , {V}_{k}^{+} )$$

where the plus superscrips represent the posterior estimates. Therefore, by substituting the mean and covariance of μₖ, i.e., E_{μk}[μₖ]=\hat{μ}ₖ⁺ and

$${cov}_{μ k} ( {μ}_{k} ) = \frac{{R}_{k}}{{λ}_{k}^{+}}$$

in Eq. [16], and taking the expectation with respect to Rₖ, the equation becomes

$${E}_{{μ}_{k} , {R}_{k}} [ {( {y}_{k} - {h}_{k} ( {θ}_{k} ) - {μ}_{k} )}^{T} {R}_{k}^{- 1} ( {y}_{k} - {h}_{k} ( {θ}_{k} ) - {μ}_{k} ) ] = {( {y}_{k} - {h}_{k} ( {θ}_{k} ) - {\hat{μ}}_{k}^{+} )}^{T} {( {\hat{R}}_{k}^{+} )}^{- 1} ( {y}_{k} - {h}_{k} ( {θ}_{k} ) - {\hat{μ}}_{k}^{+} ) + \frac{{n}_{y}}{{λ}_{k}^{+}} \qquad ( 17 )$$

It should be noted that in deriving Eq. (17), E_{R}_{ₖ}[Rₖ⁻¹]=(E_{R}_{ₖ}[Rₖ])⁻¹ in which E_{R}_{ₖ}[Rₖ] is the mean of IW distribution denoted as \hat{R}ₖ⁺, and can be calculated as follows.

$${\hat{R}}_{k}^{+} = \frac{{V}_{k}^{+}}{{v}_{k}^{+} - {n}_{y} - 1}$$

Looking back to Eq. (6), Q_{θ}(θₖ) is proportional to the exponential of E_{μ}_{_{k,}}_{R}_{ₖ}[ln(p(y_{1:k}, θₖ, μₖ, Rₖ)). So, by substituting Eq. (17) into Eq. (15) and taking exponential of Eq. (15), it can be followed that

$${Q}_{θ} ( {θ}_{k} ) ∝ exp ( - \frac{1}{2} {( {θ}_{k} - {\hat{θ}}_{k}^{-} )}^{T} {( {P}_{θ , k}^{-} )}^{- 1} ( {θ}_{k} - {\hat{θ}}_{k}^{-} ) ) \times exp ( - \frac{1}{2} {( {y}_{k} - {h}_{k} ( {θ}_{k} ) - {\hat{μ}}_{k}^{+} )}^{T} {( {\hat{R}}_{k}^{+} )}^{- 1} ( {y}_{k} - {h}_{k} ( {θ}_{k} ) - {\hat{μ}}_{k}^{+} ) ) \qquad ( 19 )$$

By linearizing hₖ(θₖ) in Eq. (19) by the first-order Taylor expansion about \hat{θ}ₖ⁻, i.e., hₖ(\hat{θ}ₖ⁻)≃hₖ(\hat{θ}ₖ⁻)+Cₖ⁻(Bk−\hat{θ}ₖ⁻), where Cₖ⁻ is the sensitivity matrix of FE model with respect to θₖ at \hat{θ}ₖ⁻, i.e.,

$${C}_{k}^{-} - \frac{\partial {h}_{k} ( {θ}_{k} )}{\partial {θ}_{k}} {\vert}_{{θ}_{k} - {\hat{θ}}_{k}^{-}} ,$$

Eq. (19) yields

$${Q}_{θ} ( {θ}_{k} ) ∝ exp ( - \frac{1}{2} {( {θ}_{k} - {\hat{θ}}_{k}^{-} )}^{T} {( {P}_{θ , k}^{-} )}^{- 1} ( {θ}_{k} - {\hat{θ}}_{k}^{-} ) ) \times exp ( - \frac{1}{2} {( {y}_{k} - {h}_{k} ( {\hat{θ}}_{k}^{-} ) - {C}_{k}^{-} ( {θ}_{k} - {\hat{θ}}_{k}^{-} ) - {\hat{μ}}_{k}^{+} )}^{T} {( {\hat{R}}_{k}^{+} )}^{- 1} ( {y}_{k} - {h}_{k} ( {\hat{θ}}_{k}^{-} ) - {C}_{k}^{-} ( {θ}_{k} - {\hat{θ}}_{k}^{-} ) - {\hat{μ}}_{k}^{+} ) ) \qquad ( 20 )$$

The first exponential term in the right-hand side of Eq. (20) shows a Gaussian distribution for θₖ ignoring the normalization term. By using Lemma 2 in the Appendix, the second exponential term in the right-hand side of Eq. (20) also represents a Gaussian distribution for θₖ. Therefore, the right-hand side of Eq. (20) is the product of two Gaussian distributions which based on Lemma 3 in the Appendix, results in a Gaussian distribution, i.e., Q_{θ}(θₖ)=N(\hat{θ}ₖ⁺, PEK). To obtain the parameters of this Gaussian distribution, we match the terms in the left-hand and the right-hand side of in Eq. (20), which results in the following two equations.

$${\hat{θ}}_{k}^{+} = {\hat{θ}}_{k}^{-} + {K}_{k} ( {y}_{k} - {h}_{k} ( {\hat{θ}}_{k}^{-} ) - {\hat{μ}}_{k}^{+} ) ) \qquad ( 21 - a )$$

$${P}_{θ , k}^{+} = {P}_{θ , k}^{-} - {K}_{k} {P}_{yy , k} {K}_{k}^{T} \qquad ( 21 - b )$$

where Kₖ=P_{θy,k}(P_{yy,k})⁻¹, P_{θy,k}=P_{θ,k}⁻(Cₖ⁻)^{T}, and P_{yy,k}=Cₖ⁻P_{θ,k}⁻(Cₖ⁻)^{T}+\hat{R}ₖ^{T}.

In a similar way, we can evaluate the expectation term in Eq. (7) as follows. Getting the mathematical expectation of Eq. (14) with respect to θₖ leads to

$${E}_{{θ}_{k}} [ ln ( p ( {y}_{1 : k} , {θ}_{k} , {μ}_{k} , {R}_{k} ) ) ] = - \frac{1}{2} ln ( \vert {R}_{k} \vert ) - \frac{1}{2} {E}_{{θ}_{k}} [ {( {y}_{k} - {h}_{k} ( {θ}_{k} ) - {μ}_{k} )}^{T} {R}_{k}^{- 1} ( {y}_{k} - {h}_{k} ( {θ}_{k} ) - {μ}_{k} ) ] - \frac{1}{2} ln ( \vert \frac{{R}_{k}}{{λ}_{k}^{-}} \vert ) - \frac{1}{2} {( {μ}_{k} - {\hat{μ}}_{k}^{-} )}^{T} {( \frac{{R}_{k}}{{λ}_{k}^{-}} )}^{- 1} ( {μ}_{k} - {\hat{μ}}_{k}^{-} ) - \frac{{v}_{k}^{-} + {n}_{y} + 1}{2} ln ( \vert {R}_{k} \vert ) - \frac{1}{2} tr ( {V}_{k}^{-} {R}_{k}^{- 1} ) + {c}_{μ , R} \qquad ( 22 )$$

where c_{μ,R} is sum of the expectation of the third, fourth, and the last term of the right-hand side of Eq. (14), and is constant with respect to μₖ, and Rₖ.

Now, consider Q_{θ}(θₖ)=N(θₖ|\hat{θ}ₖ⁺, P_{θk}⁺) and linearize hₖ(θₖ) by the first-order Taylor expansion about \hat{θ}ₖ⁺, i.e., hₖ(θₖ)≃hₖ(\hat{θ}ₖ⁺)+Cₖ⁺(θₖ−\hat{θ}ₖ⁺), where Cₖ⁺ is the sensitivity matrix of the model with respect to θₖ at \hat{θ}ₖ⁺, the expectation term in the right-hand side of Eq. (22) can be obtained as follows using Lemma 1 in Appendix.

$${E}_{{θ}_{k}} [ {( {y}_{k} - {h}_{k} ( {θ}_{k} ) - {μ}_{k} )}^{T} {R}_{k}^{- 1} ( {y}_{k} - {h}_{k} ( {θ}_{k} ) - {μ}_{k} ) ] = {( {y}_{k} - {h}_{k} ( {\hat{θ}}_{k}^{+} ) - {μ}_{k} )}^{T} {R}_{k}^{- 1} ( {y}_{k} - {h}_{k} ( {\hat{θ}}_{k}^{+} ) - {μ}_{k} ) + tr ( {C}_{k}^{+} {{P}_{θ , k}^{+} ( {C}_{k}^{+} )}^{T} {R}_{k}^{- 1} ) \qquad ( 23 )$$

Based on Eq. (7), Q_{μ,R}(μₖ, Rₖ) is proportional to the exponential of E_{θ}_{ₖ}[In(p(y_{1:k}, θₖ, μₖ, Rₖ)). Substituting Eq. (23) into Eq. (22) and taking exponential of Eq. (22), Q_{μ,R}(μₖ, Rₖ) can be found as follows.

$${Q}_{μ , R} ( {μ}_{k} , {R}_{k} ) ∝ \frac{1}{{\vert {R}_{k} \vert}^{1 / 2}} \times exp ( - \frac{1}{2} {( {y}_{k} - {h}_{k} ( {\hat{θ}}_{k}^{+} ) - {μ}_{k} )}^{T} {R}_{k}^{- 1} ( {y}_{k} - {h}_{k} ( {\hat{θ}}_{k}^{+} ) - {μ}_{k} ) ) \times \frac{1}{{\vert \frac{{R}_{k}}{{λ}_{k}^{-}} \vert}^{1 / 2}} \times exp ( - \frac{1}{2} {( {μ}_{k} - {\hat{μ}}_{k}^{-} )}^{T} {( \frac{{R}_{k}}{{λ}_{k}^{-}} )}^{- 1} ( {μ}_{k} - {\hat{μ}}_{k}^{-} ) ) \times {\vert {R}_{k} \vert}^{- ( {v}_{k}^{-} + {n}_{y} + 1 ) / 2} \times exp ( - \frac{1}{2} tr ( ( {V}_{k}^{-} + {C}_{k}^{+} {{P}_{θ , k}^{+} ( {C}_{k}^{+} )}^{T} ) {R}_{k}^{- 1} ) ) \qquad ( 24 )$$

The right-hand side of Eq. (24) includes the product of two Gaussian distributions for μₖ and one IW distribution for Rₖ. The product of these two Gaussian distributions leads to a scaled Gaussian distribution based on Lemma 3 in the Appendix. Therefore, the right-hand side of Eq. (24) results in a NIW distribution, which is a product of a Normal distribution for μₖ and an IW distribution for Rₖ. By substituting

$${Q}_{μ , R} ( {μ}_{k} , {R}_{k} ) = N ( {μ}_{k} \vert {\hat{μ}}_{k}^{+} , \frac{{R}_{k}}{{λ}_{k}^{+}} ) IW ( {R}_{k} \vert {v}_{k}^{+} , {V}_{k}^{+} )$$

in the left-hand side of Eq. (24), and using Lemma 4 in the Appendix, the four parameters of NIW distribution can be derived as follows by matching the terms in the left-and right-hand sides of Eq. (24).

$${\hat{μ}}_{k}^{+} = \frac{{λ}_{k}^{-}}{1 + {λ}_{k}^{-}} {\hat{μ}}_{k}^{-} + \frac{1}{1 + {λ}_{k}^{-}} ( {y}_{k} - {h}_{k} ( {\hat{θ}}_{k}^{+} ) ) \qquad ( 25 - a )$$

$${λ}_{k}^{+} = 1 + {λ}_{k}^{-} \qquad ( 25 - b )$$

$${v}_{k}^{+} = 1 + {v}_{k}^{-} \qquad ( 25 - c )$$

$${V}_{k}^{+} = {V}_{k}^{-} + \frac{{λ}_{k}^{-}}{1 + {λ}_{k}^{-}} ( {y}_{k} - {h}_{k} ( {\hat{θ}}_{k}^{+} ) - {\hat{μ}}_{k}^{-} ) {( {y}_{k} - {h}_{k} ( {\hat{θ}}_{k}^{+} ) - {\hat{μ}}_{k}^{-} )}^{τ} + {C}_{k}^{+} {{P}_{θ , k}^{+} ( {C}_{k}^{+} )}^{T} \qquad ( 25 - d )$$

Now having Q_{θ}(θₖ) Q_{μ,R}(μₖ, Rₖ) as an approximation for p(θₖ, μₖ, Rₖ|y_{1:k}), the expectation of Q_{θ}(θₖ) Q_{μ,R}(μₖ, Rₖ) can be evaluated to represent point estimates of unknown model parameters and noise. Therefore, \hat{θ}ₖ⁺, \hat{μ}ₖ⁺, \hat{R}ₖ⁺ represented in Eqs. (21-a), (25-a), and (18) can be considered as the point estimates for θₖ, μₖ, and Rₖ. Eqs. (21-a), (25-a), and (18) are coupled equations that can be solved iteratively using a fixed-point iteration algorithm. It is worth noting that Eqs. (21-a) and (21-b) are similar to non-adaptive Bayesian model updating formulations except the term \hat{μ}ₖ⁺, which is added in Eq. (21-a) to consider non-zero mean prediction error.

The proposed algorithm of recursive VB for joint model and noise identification is presented in Table 3 below. Like other recursive Bayesian model updating algorithms, the proposed algorithm has two steps at each time k: “prediction” and “correction.” In the “prediction” step, the new measurement yₖ at time k is not given to the estimation process yet. Therefore, the prior estimates of the statistical parameters of the Gaussian distribution of θₖ, and the NIW distribution of μₖ and Rₖ, denoted by minus superscript, are predicted through a dynamic model using their posterior estimates at the previous time step k−1. Eq. (1) can be used as the dynamic model for unknown model parameters of θₖ to obtain \hat{θ}ₖ⁻ and P_{θ,k}⁻. For predicting the prior estimates of the four parameters of NIW distribution, \hat{μ}ₖ⁻, λₖ⁻, νₖ⁻, and Vₖ⁻, the dynamic models defined above can be used considering the forgetting factor parameters of ρ ∈ E (0,1] and ρ′ ∈ (0,1]. In the “correction” step, the prior estimates are corrected by the new measurement yₖ to get the posterior estimates, denoted by plus superscript, using Eqs. (21), (25), and (18) in an iterative way. In each iteration, the model-predicted responses and the sensitivity matrix need to be updated based on the updated unknown model parameters \hat{θ}ₖ⁺. However, calculating sensitivity matrix at each time step can be computationally demanding. To reduce the execution time, the prior sensitivity matrix Cₖ⁻ in Eq. (25-d) can be used. Since the convergence criteria are not changed, using Cₖ⁻ instead of Cₖ⁺ has no effect on the final estimation results.

TABLE 3
Algorithm for recursive variational Bayesian (VB) method.

```
Initialize: \hat{θ}₀⁺, P_{θ,0}⁺, \hat{μ}_{θ}⁺, λ₀⁺, v₀⁺, and V₀⁺
Set Q, p, and p′
For each time step k (k = 1, 2, . . . , N)
  Prediction step:
    \hat{θ}ₖ⁻ = \hat{θ}ₖ₋₁⁺
    P_{θ,k}⁻ = P_{θ,k-1}⁺ + Q
    \hat{μ}ₖ⁻ = \hat{μ}ₖ₋₁⁺
    λₖ⁻ = p′λₖ₋₁⁺
    vₖ⁻ = p(vₖ₋₁⁺ − n_{y} − 1) + n_{y} + 1
    Vₖ⁻ = ρVₖ₋₁⁺
    Run the model with \hat{θ}ₖ⁻ to find the response vector, hₖ(\hat{θ}ₖ⁻), and the response
    sensitivity matrix Cₖ⁻.
  Correction step:
    \hat{θ}ₖ⁺⁽⁰⁾ = \hat{θ}ₖ⁻, P_{θ,k}⁺⁽⁰⁾ = P_{θ,k}⁻, \hat{μ}ₖ⁺⁽⁰⁾ = \hat{μ}ₖ⁻, Vₖ⁺⁽⁰⁾ = Vₖ⁻
    λₖ⁺ = 1 + λₖ⁻, vₖ⁺ = 1 + vₖ⁻
    P_{θy,k} = P_{θ,k}⁻(Cₖ⁻)^{T}
    Lₖ⁻ = Cₖ⁻P_{θ,k}⁻(Cₖ⁻)^{T}
    Iterate (j = 0, 1, . . .):
      ${\hat{R}}_{k}^{+ ( j )} = \frac{{V}_{k}^{+ ( j )}}{\text{?} - \text{?} - \text{?}}$
      P_{yy,k}^{(j)} = Lₖ⁻ + \hat{R}ₖ^{+ (j)}
      Kₖ^{(j)} = P_{θy,k} (P_{yy,k}^{(j)})⁻¹
      \hat{θ}ₖ^{+(j+1)} = \hat{θ}ₖ⁻ + Kₖ^{(j)}(yₖ − hₖ(\hat{θ}ₖ⁻) − \hat{μ}ₖ^{+(j)}))
      P_{θ,k}^{+(j+1)} = P_{θ,k}⁻ − Kₖ^{(j)}P_{yy,k}^{(j)}(Kₖ^{(j)})^{T}
      Run the model with \hat{θ}ₖ^{+(j+1)} to find the response vector, hₖ (\hat{θ}ₖ^{+(j+1)})
      Lₖ^{+(j+1)} = Cₖ⁻P_{θ,k}^{+(j+1)}(Cₖ⁻)^{T}
      ${\hat{μ}}_{k}^{+ ( j + 1 )} = \frac{\text{?}}{1 + {λ}_{k}^{-}} {\hat{μ}}_{k}^{-} + \frac{1}{1 + {λ}_{k}^{-}} ( {y}_{k} - h \text{?} ( {\hat{θ}}_{k}^{+ ( j + 1 )} ) )$
      ${V}_{k}^{+ ( j + 1 )} = {V}_{k}^{-} + \frac{{λ}_{k}^{-}}{1 + {λ}_{k}^{-}} ( {y}_{k} - {h}_{k} ( {\hat{θ}}_{k}^{+ ( j + 1 )} ) - {\hat{μ}}_{k}^{-} ) {( {y}_{k} - {h}_{k} ( {\hat{θ}}_{k}^{+ ( j + 1 )} ) - {\hat{μ}}_{k}^{-} )}^{T} + {L}_{k}^{+ ( j + 1 )}$
      $Check for convergence : If \frac{‖ \hat{θ} \text{?} - \text{?} ‖}{‖ \text{?} \text{?} \text{?} ‖} \leq 0.01 , \frac{‖ \hat{μ} \text{?} - \hat{μ} \text{?} ‖}{‖ \text{?} \text{?} \text{?} ‖} \leq 0.01 , and$
      $\frac{‖ \hat{R} \text{?} \text{?} - \hat{R} \text{?} \text{?} ‖}{‖ \hat{R} \text{?} ‖} \leq 0.01 , then move to the next step ; otherwise , j = j +$
      1 and iterate again.
  Set \hat{θ}ₖ⁺ = \hat{θ}ₖ^{+(j)}, P_{θ,k}⁺ = P_{θ,k}^{+(j)}, \hat{μ}ₖ⁺ = \hat{μ}ₖ^{+(j)}, Vₖ⁺ = Vₖ^{+(j)}
$\text{?} \text{indicates text missing or illegible when filed}$
```

Comparison of the VB Method with Two-step Marginal MAP Estimation Method

In this section, the proposed Variational Bayesian (VB) method is compared with the two-step marginal MAP estimation method discussed above for joint estimation of unknown model parameters and the mean vector and covariance matrix of the prediction error. The formulations of the two methods are closely similar. There are two main differences between the two methods as explained below. First, in the two-step marginal MAP estimation method the mode of IW distribution is used as \hat{R}ₖ⁺ point estimate, while in the VB method, the mean of IW distribution is assigned as \hat{R}ₖ⁺ (as shown in Table 4 below). The reason for this difference comes from the fact that the MAP approach is used in the former method, while the expectation value is used in the latter. It is worth noting that the mode and mean of IW distribution are not coincident. Second, different equations are used to calculate the term Vₖ⁺ as shown in Table 4. The equation used to calculate Vₖ⁺ in the VB method has an additional term, i.e., Cₖ⁻P_{θ,k}⁺(Cₖ⁻)^{T}.

In most applications, these two differences have negligible effects on the results because of the following reasons. First, the difference between the mode and mean of IW distribution decreases in higher time steps as the value of νₖ⁺ increases in time in the denominator of the characterizing equations of \hat{R}ₖ⁺. Second, as the covariance matrix of the unknown model parameters P_{θ,k}⁻ decrease through the Bayesian estimation, the effects of this extra term on the results can also become negligible. Therefore, in most applications the final estimation results from the two methods are similar.

TABLE 4
Differences between the proposed VB method and two-step
marginal MAP estimation method.

| Methods | \hat{R}ₖ⁺ | Vₖ⁺ |
|---|---|---|
| Variational Bayesian | ${\hat{R}}_{k}^{+} = \frac{{V}_{k}^{+}}{{v}_{k}^{+} - {n}_{y} - 1}$ | $\begin{matrix}{V}_{k}^{+} = {V}_{k}^{-} + \frac{{λ}_{k}^{-}}{1 + {λ}_{k}^{-}} ( {y}_{k} - {h}_{k} ( {\hat{θ}}_{k}^{+} ) - {\hat{μ}}_{k}^{-} ) \\ {( {y}_{k} - {h}_{k} ( {\hat{θ}}_{k}^{+} ) - {\hat{μ}}_{k}^{-} )}^{T} + \\ {C}_{k}^{-} {{P}_{θ , k}^{+} ( {C}_{k}^{-} )}^{T}\end{matrix}$ |
| Two-step marginal MAP estimation | ${\hat{R}}_{k}^{+} = \frac{{V}_{k}^{+}}{{v}_{k}^{+} + {n}_{y} + 1}$ | $\begin{matrix}{V}_{k}^{+} = {V}_{k}^{-} + \frac{{λ}_{k}^{-}}{1 + {λ}_{k}^{-}} ( {y}_{k} - {h}_{k} ( {\hat{θ}}_{k}^{+} ) - {\hat{μ}}_{k}^{-} ) \\ {( {y}_{k} - {h}_{k} ( {\hat{θ}}_{k}^{+} ) - {\hat{μ}}_{k}^{-} )}^{T}\end{matrix}$ |

### Numerical Study

In this section, the estimation results of the two disclosed methods are compared through a numerical study. Performance of the proposed VB method is similarly evaluated when applied to a numerical model of a 3-story 1-bay steel moment frame structure under earthquake excitation. The estimation results are compared with the two-step marginal MAP estimation method discussed above and a non-adaptive Bayesian model updating method. The story height and the bay width are 3.5 m and 6.0 m, respectively, as shown in FIG. 2A. The frame geometric and material properties are similar to the one used for the two-step marginal MAP estimation method. The numerical model of the frame is developed in OpenSees. For this, force-based beam-column elements with seven integration points are used for columns and beams. A single fiber is used to represent each flange of beam and column cross sections, while ten fibers are used to discretize their webs. The uniaxial Giuffre-Menegotto-Pinto (GMP) material model with primary parameters

$${θ}^{true} = {[ {E}_{c}^{true} , {F}_{yc}^{true} , {b}_{c}^{true} , {E}_{b}^{true} , {F}_{yb}^{true} , {b}_{b}^{true} ]}^{T} = {[ 200 GPa , 350 MPa , 0.08 , 200 GPa , 250 MPa , 0.05 ]}^{T}$$

is used to model the steel fibers and simulate the nominal/true dynamic response of the structure, where E=Young's modulus, Fy=yield stress, and b=strain-hardening ratio. The first three parameters denoted by subscript “c” are for columns, and the last three parameters denoted by subscript “b” are used for beams. A nodal mass m=80,000 kg, shown by black circle in FIG. 2A, is considered for each story at the beam-column nodes to represent dead and live mass. To model damping energy dissipation, Rayleigh damping with 2% damping ratio is considered for the first two vibration modes of the structure. To simulate measurement data, the frame structure is excited by Loma Prieta earthquake (0° component at Los Gatos station) as shown in FIG. 2B. Then, the horizontal absolute acceleration response time histories of each floor (shown by black boxes in FIG. 2A) are extracted and contaminated with artificial measurement noise to result in simulated measurement data. The measurement noise is considered as a non-stationary Gaussian random process with time-variant mean vector μₖ^{true} and covariance matrix Rₖ^{true} as follows.

$${μ}_{k}^{true} = {[ 1.97 , 5.41 , 7.5 ]}^{T} \times sin ( \frac{4 π}{N} k ) \times {10}^{- 2} g \qquad ( 26 )$$

$${R}_{k}^{true} = [ \begin{matrix}1.66 & 0 & 0 \\ 0 & 2.88 & 0 \\ 0 & 0 & 7.65\end{matrix} ] \times {( sin ( \frac{π}{N} k ) + 1 )}^{2} \times {10}^{- 4} {g}^{2} \qquad ( 27 )$$

The goal is to estimate the unknown model parameters θ=[E_{c}, F_{yc}, b_{c}, E_{b}, F_{yb}, b_{b}]^{T} and compare them with their true values θ^{true}. The initial estimate of the unknown model parameters and its covariance matrix are selected as \hat{θ}₀⁺=[0.7 E_{c}^{true}, 0.7 F_{yc}^{true}, 1.2 b_{c}^{true}, 0.8 E_{b}^{true}, 1.3 F_{yb}^{true}, 0.8 b_{b}^{true}]^{T} and P_{θ,0}⁺=diag (0.2 \hat{θ}₀⁺)², respectively. The initial mean vector and covariance matrix of the prediction error are assumed as

$${\hat{μ}}_{0}^{+} = 0 and {\hat{R}}_{0}^{+} = [ \begin{matrix}1.66 & 0 & 0 \\ 0 & 2.88 & 0 \\ 0 & 0 & 7.65\end{matrix} ] \times {10}^{- 6} {g}^{2}$$

respectively. Other initial parameters of the NIW distribution are selected as λ₀⁺=1, ν₀ ⁺=4.1, and V₀⁺=(ν₀⁺−n_{y}−1) \hat{R}₀⁺ with n_{y}=3. The process noise covariance matrix is selected as Q=diag(10⁻⁴\hat{θ}₀⁺)² and the forgetting factor parameters used for defining dynamic model of the mean vector and covariance matrix of the prediction error are assumed as ρ=0.95 and ρ′=0.95. Now, the proposed VB method is applied to estimate jointly the unknown model parameter vector θ and the mean vector and covariance matrix of prediction error. In this verification study, the results are compared with the two-step marginal MAP estimation method discussed above and the non-adaptive Bayesian model updating method when using the same initial values. As mentioned before, in the non-adaptive Bayesian method, a zero-mean Gaussian white noise with a time-variant diagonal covariance matrix is assumed for the prediction error ωₖ, i.e., ωₖ˜N (0, \hat{R}ₖ=R₀⁺).

This non-limiting method example use the VB approach and proposes an adaptive VB model updating method for joint model and noise identification. Detailed mathematical derivation is provided herein. To evaluate the performance of the proposed method, a 3-story 1-bay nonlinear steel moment frame subjected to earthquake excitation was used, in which six parameters characterizing the constitutive models of the steel beams and columns were considered as unknown. Absolute acceleration responses at each floor contaminated by Gaussian noise with time-variant mean vector and covariance matrix were considered as measurement data. The estimation results showed that the proposed VB method can accurately estimate both unknown model parameters and time-variant mean vector and covariance matrix of the prediction error. The proposed VB method was also compared to a two-step marginal MAP estimation method, and the non-adaptive Bayesian model updating method. The results showed that both adaptive methods have comparable performance while the non-adaptive method resulted in significantly biased estimations due to the adverse effects of non-stationary measurement noise.

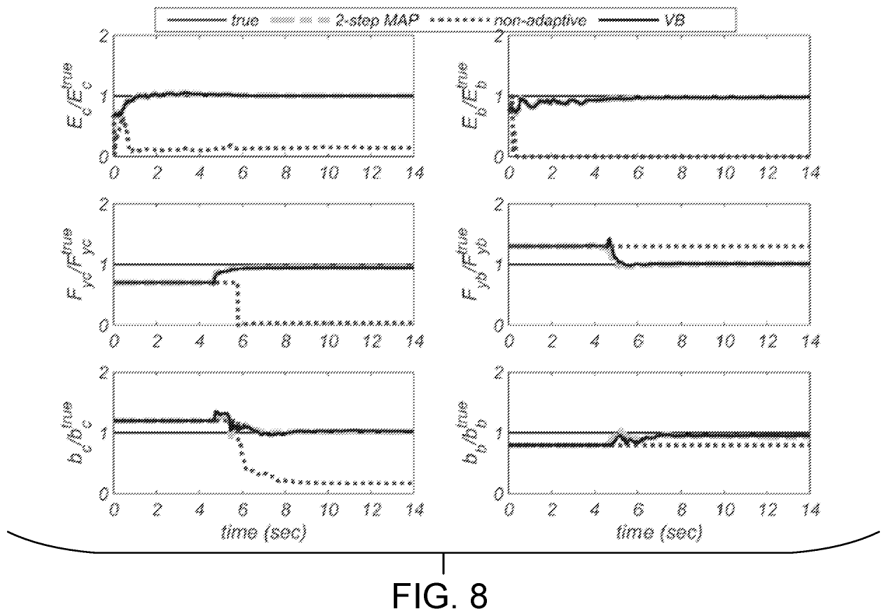

FIG. 8 shows the time histories of the unknown model parameters estimated by all three methods: the proposed VB method, the two-step marginal MAP estimation method, and the non-adaptive Bayesian method. It can be observed that both the proposed VB method and the two-step marginal MAP estimation method can accurately estimate all six unknown model parameters. However, the non-adaptive model updating method converges to incorrect unknown model parameters, or even diverges. This shows that estimation of the statistical parameters of prediction error affects the model updating results significantly when modeling error is time-variant and therefore, shall not be ignored.

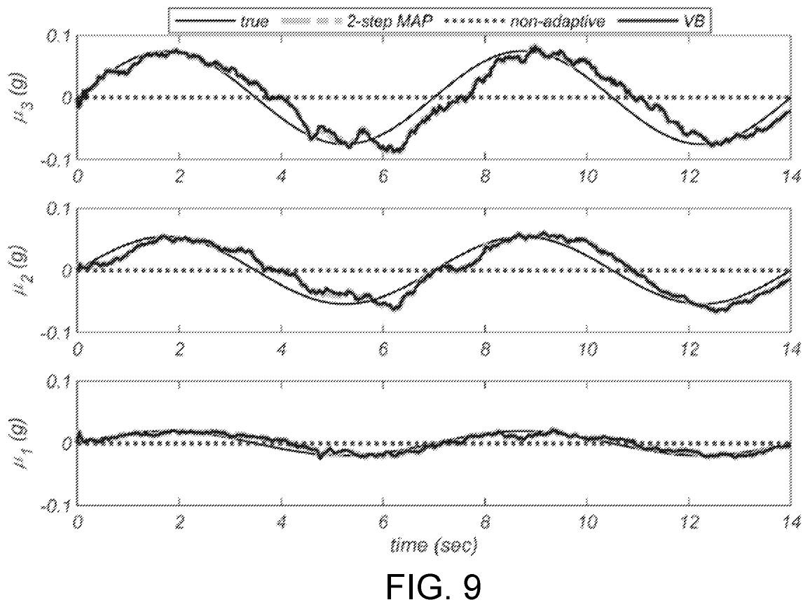

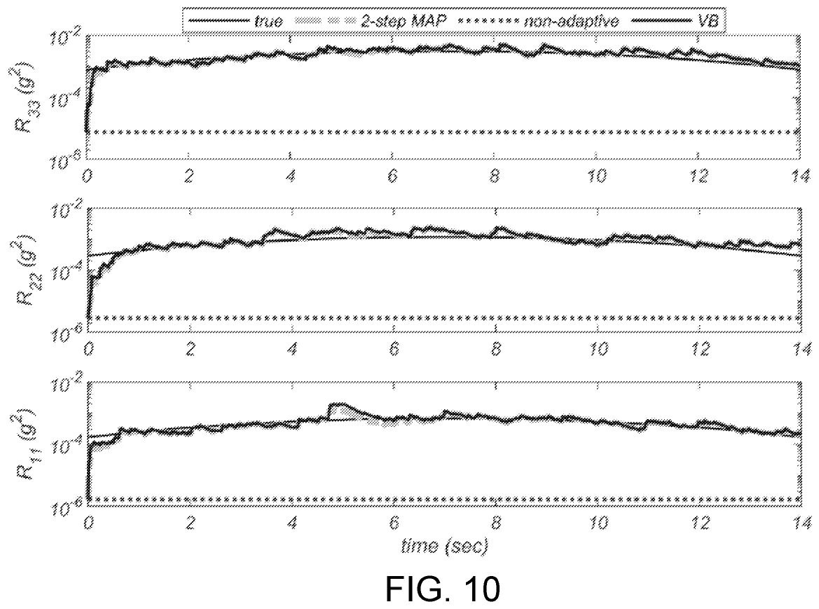

The estimated mean and variance of the prediction error (measurement noise in this example) for each channel are compared with their true values in FIG. 9 and FIG. 10, respectively. The non-adaptive Bayesian model updating method, as mentioned before, cannot estimate the mean and variance of the prediction error, so they remain constant during the estimation process. However, both the VB and the two-step marginal MAP estimation methods can accurately track the trend of the true/nominal mean and covariance of error through the time. There is a negligible difference between the estimations obtained from these two adaptive methods.

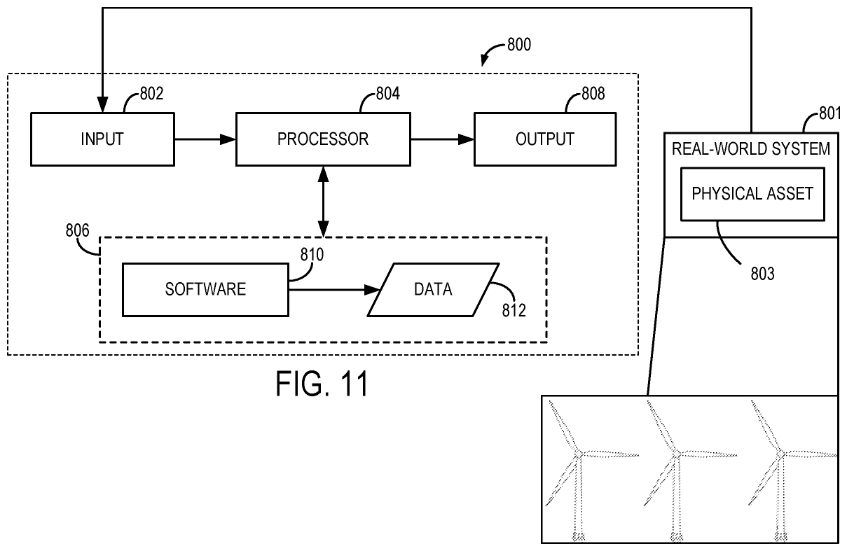

Referring now to FIG. 11, a block diagram of an example of a computer system 800 that can perform the methods described in the present disclosure is shown. The computer system 800 generally includes an input 802, at least one hardware processor 804, a memory 806, and an output 808. Thus, the computer system 800 is generally implemented with a hardware processor 804 and a memory 806. A real-world system 801, such as a physical system, may include a component or physical asset 803 as a subsystem.

In some embodiments, the computer system 800 can be a remote server or cloud-based system. The computer system 800 may also be implemented, in some examples, by a workstation, a notebook computer, a tablet device, a mobile device, a multimedia device, a network server, a mainframe, one or more controllers, one or more microcontrollers, or any other general-purpose or application-specific computing device.

The computer system 800 may operate autonomously or semi-autonomously, or may read executable software instructions from the memory 806 or a computer-readable medium (e.g., a hard drive, a CD-ROM, flash memory), or may receive instructions via the input 802 from a user, or any another source logically connected to a computer or device, such as another networked computer or server. Thus, in some embodiments, the computer system 800 can also include any suitable device for reading computer-readable storage media.

In general, the computer system 800 is programmed or otherwise configured to implement the methods and algorithms described in the present disclosure. For instance, the computer system 800 can be programmed to implement a learning network or data assimilation process, such as an adaptive or recursive Bayesian inference framework for digital twin modeling.

The input 802 may take any suitable shape or form, as desired, for operation of the computer system 800, including the ability for selecting, entering, or otherwise specifying parameters consistent with performing tasks, processing data, or operating the computer system 800. In some aspects, the input 802 may be configured to receive data, such as sensor data from the real-world system 801 where sensors may be used to monitor the real-world system 801 or the physical asset 803 as described above. In a non-limiting example, the real-world system is an OWT, and the physical asset is a component of the OWT. Such data may be processed as described above to train a physics-based model. In addition, the input 802 may also be configured to receive any other data or information considered useful for an adaptive or recursive Bayesian inference framework using the methods described above.

Among the processing tasks for operating the computer system 800, the one or more hardware processors 804 may also be configured to carry out any number of post-processing steps on data received by way of the input 802.

The memory 806 may contain software 810 and data 812, such as data acquired with the sensors, and may be configured for storage and retrieval of processed information, instructions, and data to be processed by the one or more hardware processors 804. In some aspects, the software 810 may contain instructions directed to a program to implement an adaptive or recursive Bayesian inference framework.

In addition, the output 808 may take any shape or form, as desired, and may be configured for displaying results or a prediction for a physical system based upon the results of the physics-based model in addition to other desired information.

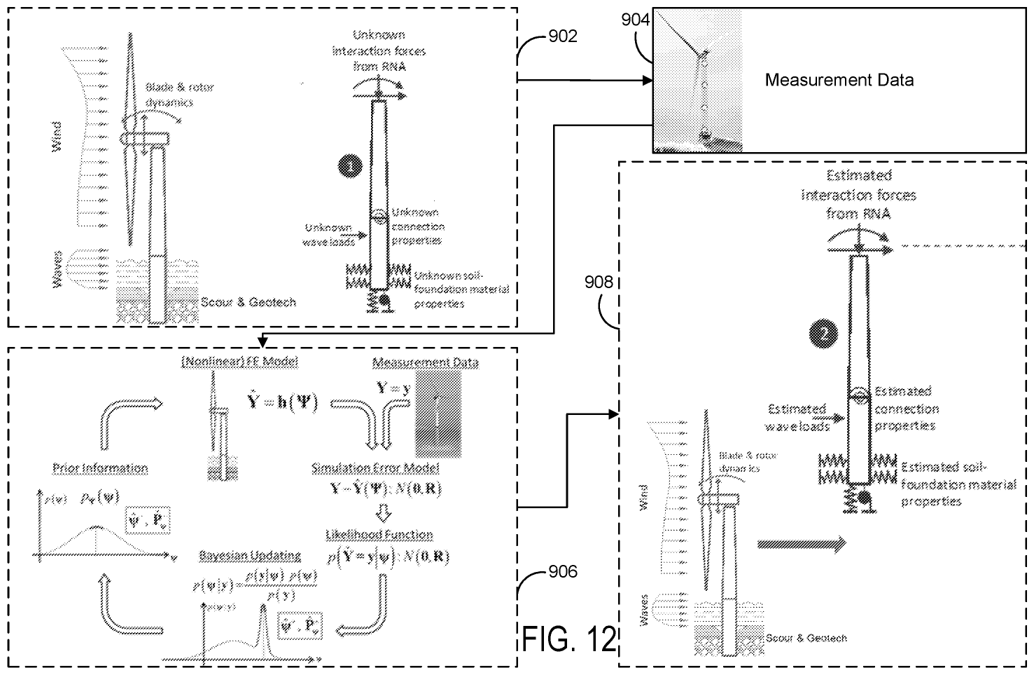

Referring to FIG. 12, a block diagram is shown for generating a physics based digital twin 908 from physics based model 902, measurement data 904, and Bayesian inference approach 906. The physics based model 902 characterizes the dynamics of the system as described above, such nonlinear behavior of foundation, dynamic interaction of the soil and support structure, and the like. In some configurations, the physics based model 902 may be a finite element model based on physically-meaningful parameters, such as foundation stiffness, aerodynamic damping parameters, and the like, as non-limiting examples. The exact values of the finite element models may be unknown or uncertain input exciting forces, such as wind and wave loads that are unknown and unmeasurable. Inherent modeling errors that stem from the mathematical idealizations and approximations may be included in the physics base model 902.

In a non-limiting example, measurement data 904 may include heterogeneous measurements on an OWT using sparse set of sensors. Bayesian inference approach 906 may include an estimate model input parameters, and or may characterize modeling errors.

The physics based digital twin 908 may be calibrated using estimated input parameters. As described above, the physics based digital twin 908 may estimate the consumed fatigue life in different components.

### Appendix

This appendix includes four Lemmas used in deriving VB method relationships as discussed above.

Lemma 1: Expectation of a quadratic form

Considering vector x ∈ [symbol] ^{nx}^{^{×1}}, and symmetric matrix A ∈ [symbol] ^{nx}^{^{×n}}^{x}, the expectation of quadratic form x^{T}Ax can be obtained as follows

$${E}_{x} ( {x}^{T} Ax ) = {μ}^{T} A μ + tr ( A \sum ) \qquad ( 28 )$$

where tr(.) denotes matrix trace, μ=Eₓ(x), and Σ=covₓ(x), in which Eₓ(.) and covₓ(.) represent the expectation and covariance with respect to x.
Lemma 2: Canonical form of a multivariate Gaussian distribution

The canonical representation of a multivariate Gaussian (Normal) distribution of p(x)=N(x̅, Σ) can be derived as

$$p ( x ) = exp ( - \frac{1}{2} {x}^{T} Λ x + {η}^{T} x + ξ ) \qquad ( 29 )$$

where

$$Λ = {\sum }^{- 1} . η = {\sum }^{- 1} \overline{x} . ξ = - \frac{1}{2} ( {n}_{x} ln ( 2 π ) + ln \vert \sum \vert + {\overline{x}}^{T} {\sum }^{- 1} \overline{x} ) or ξ = - \frac{1}{2} ( {n}_{x} ln ( 2 π ) + ln \vert {Λ}^{- 1} \vert + {η}^{T} {Λ}^{- 1} η ) ,$$

and |.| denotes matrix determinant.
Lemma 3: Product of two multivariate Gaussian distributions

If x₁ ∈ [symbol] ^{nx}^{^{×1}} and x₂ ∈ [symbol] ^{nx}^{^{×1}} are two independent random vectors with Gaussian distributions, i.e., p₁(x)=N(x̅₁, Σ₁) and p₂(x)=N(x̅₂, Σ₂), then the product of

$$exp ( - \frac{1}{2} {x}^{T} ( {Λ}_{1} + {Λ}_{2} ) x + {( {η}_{1} + {η}_{2} )}^{T} x + ( {ξ}_{1} + {ξ}_{2} ) ) \qquad ( 30 )$$

these two distributions can be obtained as follows using the canonical form presented in Lemma 2.

Using the following definitions

$$Λ = {Λ}_{1} + {Λ}_{2} \qquad ( 31 )$$

$$η = {η}_{1} + {η}_{2}$$

$$ξ = - \frac{1}{2} ( {η}_{x} ln ( 2 π ) + ln \vert {Λ}^{- 1} \vert + {η}^{T} {Λ}^{- 1} η )$$

Eq. (30) can be written as

$${p}_{1} ( x ) \times {p}_{2} ( x ) = exp ( - \frac{1}{2} {x}^{T} Λ x + {η}^{T} x + ξ ) \times exp ( {ξ}_{1} + {ξ}_{2} - ξ ) \qquad ( 32 )$$

Comparing Eqs. (29) and (32), it can be observed that the product of the two Gaussian distributions will be a scaled Gaussian distribution x˜N (x̅, Σ) with the scale factor of exp(ξ₁+ξ₂−ξ) and the mean vector x̅ and the covariance matrix Σ as

$$\overline{x} = {Λ}^{- 1} η = {( {Λ}_{1} + {Λ}_{2} )}^{- 1} ( {η}_{1} + {η}_{2} ) = {( {\sum }_{1}^{- 1} + {\sum }_{2}^{- 1} )}^{- 1} ( {\sum }_{1}^{- 1} {\overline{x}}_{1} + {\sum }_{2}^{- 1} {\overline{x}}_{2} ) \qquad ( 33 )$$

$$\sum = {Λ}^{- 1} = {( {Λ}_{1} + {Λ}_{2} )}^{- 1} = {( {\sum }_{1}^{- 1} + {\sum }_{2}^{- 1} )}^{- 1}$$

Lemma 4: Trace of a quadratic form

Considering vector x ∈ [symbol] ⁿ^{ₓ}^{×1}, and matrix A ∈ [symbol] ⁿ^{ₓ}^{×n}^{ₓ}, the quadratic form x^{T}Ax which is a 1×1 matrix can be also represented as

$${x}^{T} Ax = tr ( {Axx}^{T} ) = tr ( {xx}^{T} A ) \qquad ( 34 )$$

where tr(.) denotes matrix trace.

The present disclosure has described one or more preferred embodiments, and it should be appreciated that many equivalents, alternatives, variations, and modifications, aside from those expressly stated, are possible and within the scope of the invention.

1. A method for managing a physical system with a computer system comprising:
a) accessing, with the computer system, a physics-based model of at least one physical asset in the physical system;
b) collecting sensor data from sensors configured to record a parameter of the at least one physical asset;
c) subjecting the physics-based model and the sensor data to a data assimilation process to generate model parameters and input loads from the sensor data for the at least one physical asset and quantify a prediction error;
d) updating the physics-based model based upon the model parameters, input loads, and the quantified prediction error to generate a physics-based digital twin; and
e) directing operation of the physical system using the physics-based digital twin and the input loads.

2. The method of claim 1, wherein the physical system is an offshore wind turbine system and the physics-based model includes the at least one physical asset of the offshore wind turbine system.

3. The method of claim 2, wherein at least one of the recorded parameter or model parameters include at least one of demand, wear, life expectancy of the physical asset, or maintenance.

4. The method of claim 3, wherein directing operation of the physical system includes directing maintenance by predicting a remaining life expectancy of the physical asset based upon the updated physics-based model.

5. The method of claim 2, wherein the physical asset is at least one of blades, blade pitch system, gearboxes, drivetrain, hardware, bearings, tower, rotor, rotor shaft, brakes, electrical components, control software, electrical generator, power cabling, wind sensors/anemometer or wind vane, yaw system, nacelle, drivetrain bearing, or consumable component of the offshore wind turbine system.

6. The method of claim 1, wherein the data assimilation process is a learning network that includes an adaptive recursive Bayesian inference framework to jointly estimate the model parameters, input loads, and statistical characteristics of the quantified prediction error that includes effects of modeling error and measurement noise.

7. The method of claim 6, wherein the statistical characteristics include at least one of a mean vector or a covariance matrix of the prediction error, or a combination thereof.

8. The method of claim 6, wherein the prediction error is modeled as a non-stationary Gaussian random process with a time-variant mean vector and covariance matrix.

9. The method of claim 1, wherein steps c) and d) are repeated until a threshold convergence is achieved.

10. The method of claim 1, wherein the sensors include at least one of cameras, optical detectors, friction gauges, force gauges, accelerometers, strain gauges, clearance gauges, or electrical current detectors.

11. A system for modeling a physical asset comprising:
a computer system configured to:
i) access a physics-based model of the physical asset in a physical system;
ii) collect sensor data from sensors configured to record a parameter of the physical asset;
iii) subject the physics-based model and the sensor data to a data assimilation process to generate model parameters and input loads from the sensor data for the physical asset and quantify a prediction error; and
iv) update the physics-based model based upon the model parameters, input loads, and the quantified prediction error to generate a physics-based digital twin.

12. The system of claim 11, wherein the physical system is an offshore wind turbine system and the physics-based model includes the physical asset of the offshore wind turbine system.

13. The system of claim 12, wherein at least one of the recorded parameter or model parameters include at least one of demand, wear, life expectancy of the physical asset, or maintenance.

14. The system of claim 13, wherein the computer system is further configured to control operation of the physical system including the physical asset using the physics-based digital twin, and
wherein controlling operation of the physical system includes directing maintenance by predicting a remaining life expectancy of the physical asset based upon the physics-based digital twin.

15. The system of claim 12, wherein the physical asset is at least one of blades, blade pitch system, gearboxes, hardware, bearings, tower, rotor, rotor shaft, brakes, grease, electrical components, control software, electrical generator, power cabling, wind sensors/anemometer or wind vane, yaw system, nacelle, drivetrain bearing, or consumable component of the offshore wind turbine system.

16. The system of claim 11, wherein the data assimilation process is a learning network that includes an adaptive recursive Bayesian inference framework to jointly estimate the model parameters, input loads, and statistical characteristics of the quantified prediction error that includes effects of modeling error and measurement noise.

17. The system of claim 16, wherein the statistical characteristics include at least one of a mean vector or a covariance matrix of the prediction error, or a combination thereof.

18. The system of claim 16, wherein the prediction error is modeled as a non-stationary Gaussian random process with a time-variant mean vector and covariance matrix.

19. The system of claim 11, wherein steps iii) and iv) are repeated until a threshold convergence is achieved.

20. The system of claim 11, wherein the sensors include at least one of cameras, optical detectors, friction gauges, force gauges, accelerometers, strain gauges, clearance gauges, or electrical current detectors.
